(19) United States
(12) Patent Application Publication
(10) Pub. No.: US 2022/0259408 A1
(43) Pub. Date: Aug. 18, 2022

(54) FUNCTIONALIZED POLYMER FOR BATTERY APPLICATIONS

(71) Applicant: Conamix Inc., Ithaca, NY (US)

(72) Inventors: Stephen Burkhardt, Ithaca, NY (US); Christopher A. Simoneau, Trumansburg, NY (US)

(21) Appl. No.: 17/763,045

(22) PCT Filed: Sep. 25, 2020
(86) PCT No.: PCT/US20/52885

§ 371 Date: Mar. 23, 2022

Related U.S. Application Data
(60) Provisional application No. 62/906,869, filed on Sep. 27, 2019.

(51) Int. Cl. C08K 13/02

(52) U.S. Cl. CPC C08K 13/02

(57) ABSTRACT

This application relates to nanostructured materials, such as nanoparticles, comprising anion-functionalized conductive polymers and methods of making same. The nanostructures may be used as electrode materials for secondary batteries or other energy storage devices.

### CROSS-REFERENCE TO RELATED APPLICATIONS

This application claims priority to and benefit of U.S. Provisional Patent Application No. 62/906,869, filed Sep. 27, 2019, the contents of which are hereby incorporated by reference herein in their entirety.

### TECHNICAL FIELD

This application relates to nanostructured materials comprising functionalized polymers; the nanostructured materials have utility in the manufacture of compositions for secondary batteries and other energy storage devices.

### BACKGROUND

A major objective in the commercial development of next generation rechargeable batteries is to provide batteries with higher energy densities than state of the art lithium ion batteries. One of the most promising approaches to this goal is use of a sulfur cathode coupled with a lithium metal anode. Sulfur is inexpensive, abundant, and offers a theoretical charge capacity that is an order of magnitude higher than conventional metal oxide-based intercalation cathodes used in current lithium ion cells. Similarly, anodes based on metallic lithium have higher energy density than the lithium graphite anodes used in current lithium ion cells.

However, the manufacture of a practical lithium sulfur battery has been an elusive goal. Among the challenges that plague sulfur cathodes, one of the most serious arises from dissolution of lithium polysulfide intermediates formed during battery discharge. These compounds are soluble in electrolytes and difficult to retain at the cathode. In addition, sulfide anions are highly nucleophilic which creates incompatibility with many of the chemicals used in commercial lithium ion batteries. In particular, sulfides readily react with the alkylene carbonates that are typically used as electrolytes in lithium ion batteries. Because of this, ethereal electrolytes such as dimethoxyethane (DME) and 1,3-dioxolane (DOL) are widely used in place of carbonates in sulfur batteries. Unfortunately, ethereal solvents are oxidatively unstable, highly flammable, and do not form stable solid electrolyte interfaces (SEIs) on lithium anodes. This is a consternating problem and developing a high-performance system that simultaneously satisfies the divergent demands of sulfur cathodes and lithium metal anodes remains an elusive goal.

Thus, although elemental sulfur has been under investigation as a battery cathode material for more than 50 years, fundamental problems have yet to be solved to enable widespread commercialization. Although incremental improvements in capacity and cycle lifetime of lithium sulfur batteries have been made, significant improvements are needed to prevent polysulfide loss and to create system chemistries that are compatible with sulfur chemistry and lithium metal anodes.

The present invention provides solutions to these and related problems.

### SUMMARY

Among other things, the present invention encompasses the recognition that engineered nanostructured materials comprising functionalized polymers can be applied to solve problems in lithium batteries, including accommodating active material volume changes and addressing the challenges of combining electrolytes and additives optimized for various cathode materials with metallic lithium anodes.

In certain embodiments, the present invention provides nanostructured materials comprising a polymer and an electroactive sulfur composition, wherein the polymer is electrically conducting and has a structure comprising one or more anionic functional groups covalently bound to the polymer.

In certain embodiments, provided nanostructured materials are characterized in that a nanostructured material is in the form of nanoparticles. In certain such embodiments, nanoparticles have a core shell morphology. In certain such embodiments, a shell comprises an electrically conducting polymer. In certain such embodiments, a core comprises electroactive sulfur. In certain such embodiments, provided nanostructured materials are characterized in they are in the form of yolk shell nanoparticles. In certain such embodiments, a shell comprises an electrically conducting polymer, defining an interior volume, and a yolk comprises electroactive sulfur and occupies between about 20% to about 80% of interior volume defined by the shell.

The invention provides, among other things, compositions that have utility in construction of electrodes for electrochemical devices. In certain embodiments, the present invention provides mixtures for use in fabrication of a cathode comprising: nanostructured materials described herein, an electrically conducting additive, and a binder. In certain embodiments, the present invention is directed to cathodes derived from such mixtures. In certain embodiments, the present invention is directed to electrochemical cells, which comprise such cathodes.

In certain embodiments, a polymer of the nanostructured materials of the present invention comprises repeat units conforming to formula M1:

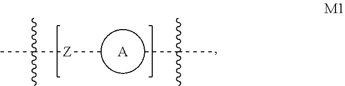

wherein:
Z is, independently at each occurrence in the polymer chain, selected from the group consisting of —N—, —NR—, —S—, and cations, radicals, radical cations or protonated versions of any of these, where R, at each occurrence is independently selected from the group consisting of —H, optionally substituted C₁₋₄ aliphatic, and optionally substituted aryl; each dashed bond may, independently at each occurrence in the polymer chain, be a single bond or a double bond in conformance with the valences and charges of the atoms connected by such bond(s); and
\textcircled{A} is a non-heterocyclic aromatic moiety, where each \textcircled{A} 0 may be the same or different at each occurrence in the polymer chain.

wherein at least a portion of the \textcircled{A} groups in the polymer are substituted with anionic functional groups.

In another aspect, the present invention provides methods of fabricating the nanostructured materials described herein.

### Definitions

In order for the present disclosure to be more readily understood, certain terms are first defined below. Additional definitions for the following terms and other terms are set forth throughout the specification.

In this application, unless otherwise clear from context, the term “a” may be understood to mean “at least one.” As used in this application, the term “or” may be understood to mean “and/or.” In this application, the terms “comprising” and “including” may be understood to encompass itemized components or steps whether presented by themselves or together with one or more additional components or steps. As used in this application, the term “comprise” and variations of the term, such as “comprising” and “comprises,” are not intended to exclude other additives, components, integers or steps.

About, Approximately: As used herein, the terms “about” and “approximately” are used as equivalents. Unless otherwise stated, the terms “about” and “approximately” may be understood to permit standard variation as would be understood by those of ordinary skill in the art. Where ranges are provided herein, the endpoints are included. Any numerals used in this application with or without about/approximately are meant to cover any normal fluctuations appreciated by one of ordinary skill in the relevant art. In some embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Aliphatic: As used herein, the term “aliphatic” may be understood to encompass a straight-chain (i.e., unbranched) or branched, substituted or unsubstituted hydrocarbon chain that is completely saturated or that contains one or more units of unsaturation, or a monocyclic hydrocarbon or bicyclic hydrocarbon that is completely saturated or that contains one or more units of unsaturation. Unless otherwise specified, aliphatic groups contain 1-12 aliphatic carbon atoms. In some embodiments, aliphatic groups contain 1-6 aliphatic carbon atoms. In some embodiments, the aliphatic groups contain 1-5 aliphatic carbon atoms. In some embodiments, aliphatic groups contain 1-4 aliphatic carbon atoms. In some embodiments aliphatic groups contain 1-3 aliphatic carbon atoms. Suitable aliphatic groups include, but are not limited to, linear or branched, substituted or unsubstituted alkyl, alkenyl, alkynyl groups, and hybrids thereof.

Electroactive Substance: As used herein, the term “electroactive substance” refers to a substance that changes its oxidation state, or partakes in a formation or breaking of chemical bonds, in a charge-transfer step of an electrochemical reaction.

Nanoparticle, Nanostructure, Nanomaterial: As used herein, these terms may be used interchangeably to denote a particle of nanoscale dimensions or a material having nanoscale structures. The nanoparticles can have essentially any shape or configuration, such as a tube, a wire, a laminate, sheets, lattices, a box, a core and shell, or combinations thereof.

Polymer: As used herein, the term “polymer” generally refers to a substance that has a molecular structure consisting chiefly or entirely of repeated sub-units bonded together, such as synthetic organic materials used as plastics and resins.

Substantially: As used herein, the term “substantially” refers to the qualitative condition of exhibiting total or near-total extent or degree of a characteristic or property of interest.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the disclosed compositions and methods and are not intended as limiting. For purposes of clarity, not every component may be labeled in every drawing. In the following description, various embodiments are described with reference to the following drawings, in which:

FIG. 1 is a pictorial representation of polymer structures (Structures A through G) in accordance with one or more embodiments of the present disclosure.

FIG. 2 is a cross-sectional representation of a nanoparticle in accordance with one or more embodiments of the present disclosure at two different states of electrochemical charge.

FIG. 3 is a cross-sectional representation of a nanoparticle in accordance with one or more embodiments of the present disclosure at three different states of electrochemical charge.

FIG. 4 is a pictorial representation and flow chart showing a method of fabricating a nanostructured material according to one or more embodiments of the present disclosure.

FIG. 5 is a pictorial representation and flow chart showing an alternate method of fabricating a nanostructured material according to one or more embodiments of the present disclosure.

FIG. 6 is a pictorial representation of a cross section of an electrochemical cell according to one or more embodiments of the present disclosure.

FIG. 7 is a pictorial representation of a cylindrical battery embodying concepts of the present disclosure.

### DETAILED DESCRIPTION

Generally, the present disclosure is directed to novel nanostructured materials for use in energy storage devices and related methods for fabricating and using such materials. While certain polymers such as polyaniline (PAni) are known to be useful as conductive polymers, it has been generally observed that certain functionalized analogs of PAni (e.g., sulfonated PAni) are less conductive than unfunctionalized PAni. Against this backdrop, the present disclosure encompasses the recognition that inclusion of anionic functional groups in conductive polymers used for manufacture of nanostructured battery components unexpectedly improves electrochemical performance of resulting batteries. While not wishing to be bound by any particular theory, it is believed that such anionic functional groups facilitate protonation (i.e., doping) of a conductive polymer, and that such “self-doped” polymers remain doped and therefore electronically conductive through a larger voltage range within the operating window of batteries operating at low voltages. Such properties are particularly valuable for high energy batteries that operate at low voltages, such as sulfur batteries.

The present disclosure thus provides, among other things, nanostructured materials (e.g., nanoparticles) which offer particular advantages as battery materials. Such anionic-functionalized polymers offer additional benefits that may include, but are not limited to: the provision of functional groups that can be lithiated and may thereby aid in lithium ion conductivity; incorporation of polar groups that interact favorably with electrolytes and aid in solvation of metal ions and electrochemical intermediates; or that prevent polysulfides from migrating through a battery. Furthermore, provided anionic particle surfaces may aid in templating of nanostructures during manufacturing processes. Further advantages of nanostructured materials (e.g., nanoparticles) functional groups are explained below.

### I. COMPOSITIONS

The present invention provides, among other things, nanostructured materials that comprise anion-functionalized conductive polymers. In certain embodiments, nanostructured materials are in the form of nanoparticles comprising anion-functionalized polymeric structures.

In certain embodiments, the present disclosure relates to nanostructured materials including the combination of an anion-functionalized polymer composition and an electroactive substance. In certain embodiments, such nanostructured materials are organized such that the anion-functionalized polymer composition provides a spatially-ordered system to control the location and electrochemical availability of the electroactive substance. Non-limiting examples of such nanostructured materials include core-shell particles, which include a shell (comprising an anion-functionalized polymer) defining an internal volume and a core (comprising an electroactive sulfur composition) disposed within an internal volume defined by a shell. In certain embodiments, provided nanostructured materials comprise yolk-shell structures. In certain embodiments, the nanostructured materials comprise a polymer shell. In certain embodiments, the nanostructured material comprises an electrically conducting polymer shell. In certain embodiments, one or more types of anionic functional group are covalently bonded to the polymer shell. In certain embodiments, the nanostructured materials comprise a polymer shell and a core comprising electroactive sulfur, wherein the polymer has a structure comprising one or more anionic functional groups covalently bonded to the polymer.

### A. Nanostructures

Before describing the specific characteristics of provided nanostructured materials and their modes of operation, this section will describe general characteristics of nanostructures encompassed by the concepts described herein (e.g. the shape, size, and the arrangement of the components within the nanostructured materials).

Nanostructured materials of the present disclosure are not limited to any specific morphology. In certain embodiments, nanostructures have a morphology that defines a contained interior volume that is physically isolated from the space outside of the nanostructured material. In certain embodiments, the inventive nanostructures have a morphology that defines a contained volume that is not physically isolated from the space outside of the nanostructured material, for example a porous or layered structure. Nanostructured materials having such characteristics may take various morphological forms and the present disclosure places no particular limitations on morphology of nanostructured materials. Non-limiting examples of nanostructured materials that may be fashioned with an interior volume separated from the exterior volume include: core shell particles, nanowires, closed-cell nanoporous foams, encapsulated nanocomposites, and related structures. Non-limiting examples of nanostructured materials that may be fashioned with an interior volume that is not physically separated from the exterior volume include: nanostructured porous materials, open-cell nanoporous foams, mesoporous solids, laminar or multilayered materials, and related structures.

In certain embodiments, provided nanostructures comprise core-shell nanoparticles. Such nanoparticles comprise a substantially continuous shell that contains an internal volume and separates that volume from the space outside of the shell. In certain embodiments, such core shell particles are substantially spherical, though other geometries are also possible, including: oblong or ovoid shapes, cylinders, prismatic shapes, irregular shapes, and polyhedral shapes. Optimal shape of nanoparticles may vary for different applications while the descriptions and examples below concentrate on spherical core shell nanoparticles as a way of demonstrating the broader principles of the present disclosure, it is to be understood that these principles apply to nanostructured materials with other morphologies and that such alternatives are contemplated within the scope of certain embodiments of the present disclosure. Control of nanoparticle morphology is well understood in the art (e.g. using techniques such as templating, surfactant control, mechanical processing, and the like) and it is therefore within the ability of the skilled person to adapt the concepts described herein with respect to spherical core shell particles to other nanostructured materials.

Generally, optimal dimensions of nanostructures may vary to suit a particular application. In various embodiments, a nanostructure is a nanoparticle (e.g. a material comprising discrete nanoscale particles). In certain embodiments, nanoparticles have an average size between about 20 nm and about 1000 nm, or between about 20 nm and about 200 nm, or between about 150 nm and about 500 nm, or between about 200 nm and about 500 nm, or between about 400 nm and about 800 nm, or between about 500 nm and about 900 nm, or between about 700 nm and about 1000 nm.

In certain embodiments, such nanoparticles have at least one dimension in the range of about 10 to about 1000 nm. In some embodiments, a nanostructured material does not comprise nanoscale particles per se but has nanoscale features, as for example in nanoporous or mesoporous solids which may be present as larger particles, monoliths, or composites which may be formed with controlled nanoscale features or constituents.

In certain embodiments, provided nanostructures comprise substantially spherical nanoparticles with a diameter in the range of about 10 to about 5000 nm. In certain embodiments, the diameter of such spherical particles is, on average, less than about 100 nm for example, provided nanoparticles may have diameters of 10 to 40 nm; 25 to 50 nm; or 50 to 100 nm. In certain embodiments, provided nanoparticles comprise spherical particles with a diameter less than about 500 nm—for example, provided nanoparticles may have diameters of 75 to 150 nm; 100 to 200 nm; 150 to 300 nm; 200 to 500 nm; or 300 to 500 nm. In certain embodiments, provided nanoparticles comprise spherical particles with a diameter less than about 1000 nm—for example, provided nanoparticles may have diameters of 200 to 600 nm; 500 to 800 nm; 600 to 800 nm; or 750 to 1000 nm. In certain embodiments, provided nanoparticles comprise spherical particles with a diameter between about 300 nm and about 800 nm. In certain embodiments, provided nanoparticles comprise spherical particles with a diameter less than about 2000 nm—for example, provided nanoparticles may have diameters of 1000 to 1200 nm; 1000 to 1500 nm; 1300 to 1800 nm; or 1500 to 2000 nm. In certain embodiments, provided nanoparticles comprise spherical particles with a diameter less than about 5000 nm—for example, provided nanoparticles may have diameters of 1000 to 2000 nm; 2000 to 3000 nm; 2500 to 3500 nm; 2000 to 4000 nm; or 3000 to 5000 nm.

In certain embodiments, provided nanoparticles comprise cylindrical particles with a cross-sectional diameter in the range of about 10 to about 1000 nm. In certain embodiments, cross-sectional diameter of such nanoparticles is less than about 100 nm—for example, provided cylindrical particles may have diameters of 10 to 40 nm; 25 to 50 nm; or 50 to 100 nm. In certain embodiments, provided cylindrical particles have a cross-sectional diameter less than about 500 nm—for example, provided cylindrical particles may have diameters of 75 to 150 nm; 100 to 200 nm; 150 to 300 nm; 200 to 500 nm; or 300 to 500 nm. In certain embodiments, provided nanoparticles comprise cylinders with a cross-sectional diameter less than about 1000 nm—for example, provided nanoparticles may have diameters of 200 to 600 nm; 500 to 800 nm; 600 to 800 nm; or 750 to 1000 nm. In certain embodiments, provided nanoparticles comprise cylindrical particles with a diameter between about 100 nm and about 400 nm. In certain embodiments, provided cylindrical particles have lengths greater than 1 μm. In certain embodiments, provided cylindrical nanoparticles have lengths greater than 5 μm, greater than 10 μm, greater than 20 μm, or greater than 50 μm. In certain embodiments, provided cylindrical nanoparticles have lengths of about 1 μm to about 1 cm. In certain embodiments, provided cylindrical nanoparticles have lengths of about 5 μm to about 1 cm. In certain embodiments, provided cylindrical nanoparticles have lengths of about 10 μm to about 1 cm. In certain embodiments, provided cylindrical nanoparticles have lengths of about 20 μm to about 1 cm. In certain embodiments, provided cylindrical nanoparticles have lengths of about 50 μm to about 1 cm. In certain embodiments, provided cylindrical nanoparticles have lengths of about 1 μm to about 1 mm. In certain embodiments, provided cylindrical nanoparticles have lengths of about 5 μm to about 1 mm. In certain embodiments, provided cylindrical nanoparticles have lengths of about 10 μm to about 1 mm. In certain embodiments, provided cylindrical nanoparticles have lengths of about 20 μm to about 1 mm. In certain embodiments, provided cylindrical nanoparticles have lengths of about 50 μm to about 1 mm. In certain embodiments, provided cylindrical nanoparticles have lengths of about 1 μm to about 100 μm. In certain embodiments, provided cylindrical nanoparticles have lengths of about 5 μm to about 100 μm. In certain embodiments, provided cylindrical nanoparticles have lengths of about 10 μm to about 100 μm. In certain embodiments, provided cylindrical nanoparticles have lengths of about 20 μm to about 100 μm. In certain embodiments, provided cylindrical nanoparticles have lengths of about 50 μm to about 100 μm. In certain embodiments, provided nanoparticles have an aspect ratio greater than 3, greater than 5, greater than 10, greater than 20. In certain embodiments, provided nanoparticles have an aspect ratio greater than 50, greater than 100, greater than 200, greater than 500, or greater than 1000.

In certain embodiments, where provided nanoparticles comprise a structure which separates an internal volume contained within a nanoparticle from a volume outside the nanoparticle (e.g. a shell or wall), such a structure may have a thickness of between about 0.5 nm and about 100 nm. Optimal thickness of such a structure will vary depending on the material from which it is made, dimensions of the nanostructure of which it is a part, and/or the specific application for which the nanoparticle is being engineered. In certain embodiments, provided nanoparticles have a shell or wall thickness less than about 15 nm—for example, having a thickness in the range of about 1 nm to about 2 nm; about 2 nm to about 5 nm; about 5 nm to about 7 nm; about 5 nm to about 10 nm; or about 10 nm to about 15 nm. In certain embodiments, provided nanoparticles have a shell or wall thickness less than about 25 nm. In certain embodiments, provided nanoparticles have a shell or wall thickness less than about 50 nm—for example, having a thickness in the range of about 5 nm to about 15 nm; about 10 nm to about 20 nm; about 15 nm to about 30 nm; about 25 nm to about 40 nm; or about 30 nm to about 50 nm. In certain embodiments, provided nanoparticles have a shell or wall thickness less than about 75 nm. In certain embodiments, provided nanoparticles have a shell or wall thickness less than about 100 nm—for example, having a thickness in the range of about 50 nm to about 60 nm; about 50 nm to about 75 nm; about 60 nm to about 80 nm; or about 75 nm to about 100 nm.

It will be appreciated that a given combination of particle shape, particle dimensions and wall thickness will together determine size of an internal volume enclosed within a particle (an ‘enclosed volume’). Shape of an enclosed volume may therefore be dictated by morphology of a nanostructured material. In various embodiments, an enclosed volume may comprise a single chamber, or it may comprise a plurality of smaller spaces that are isolated from each other or that have varying degrees of interconnectedness.

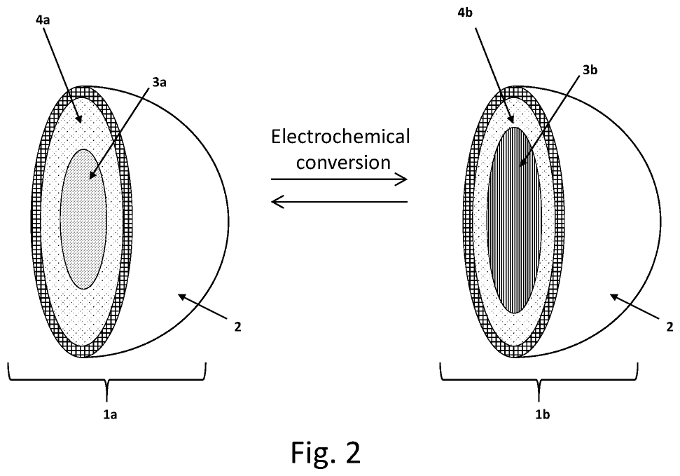

FIG. 2 depicts cross sections of a core shell nanoparticle according to the present disclosure at two different states of charge. The particle 1a on the left-hand side of FIG. 2 is depicted in a state of charge where a contained electroactive solid 3a has a first volume. In this state, the enclosed volume contains a large volume of liquid phase 4a. After electrochemical conversion, the particle is converted to state 1b where contained electroactive solid 3b has increased in volume and contained liquid phase 4b has a correspondingly reduced volume.

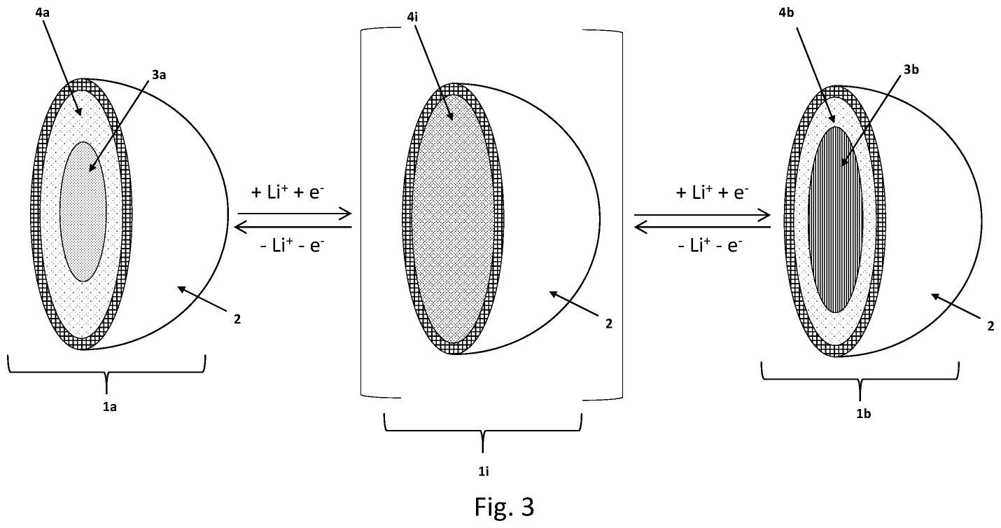

FIG. 3 further illustrates operation of certain embodiments of provided nanoparticles. FIG. 3, shows a cross sectional view of a core shell nanoparticle where the contained electroactive substance is elemental sulfur and where the particle is part of an operating lithium sulfur battery. In this case the particle 1a depicted at left-hand side of the figure is in a charged state and the contained electroactive solid 3a comprises solid sulfur. As the particle is electrochemically discharged, lithium ions and electrons enter the particle and convert the sulfur to soluble lithium polysulfides (e.g. Li₂Sₓ where 2<x<9) which dissolve in the contained liquid phase 4a leading to a particle in state 1i depicted at the center of FIG. 3. In this state, sulfur has been entirely converted to polysulfides, which have dissolved into the contained liquid phase 4i. Further discharge leads to the formation of Li₂S, which has low solubility resulting in formation of solid Li₂S core 3b in contact with liquid phase 4b. Note that solid 3b occupies a larger volume than 3a since the solid now includes the added lithium atoms and lithium sulfide has a lower density than elemental sulfur. Nonetheless, the volume contained by the shell 2 remains approximately constant during all three stages of conversion depicted in FIG. 3.

### B. Polymeric Nanostructures

As described above, certain nanostructured materials of the present disclosure are characterized in that they incorporate polymer compositions comprising anionic functional groups. In certain embodiments, such polymer compositions are incorporated into nanostructured materials as polymeric coatings on electroactive substances. In certain embodiments, such polymers are present in shells of core shell particles.

In certain embodiments, provided nanostructured materials comprise polymer shells that are nanoporous. In certain embodiments, polymer shells have pore sizes less than 5 nm; for example, less than 4 nm, less than 3 nm, less than 2 nm, or less than 1.5 nm. In certain embodiments, permeable structures have pore sizes less than 1 nm; for example, less than 0.9 nm, less than 0.8 nm, less than 0.7 nm, or less than 0.6 nm. In certain embodiments, polymer shells have pore sizes less than 0.5 nm; for example, less than 0.4 nm, less than 0.3 nm, less than 0.25 nm, less than 0.2 nm, less than 0.15 or less than 0.10 nm. In certain embodiments, polymer shells have pore sizes between about 1 nm and about 5 nm. In certain embodiments, polymer shells have pore sizes between about 1 nm and about 2 nm. In certain embodiments, polymer shells have pore sizes between about 0.5 nm and about 1.5 nm. In certain embodiments, polymer shells have pore sizes between about 0.1 nm and about 1 nm. In certain embodiments, polymer shells have pore sizes between about 0.5 nm and about 1 nm. In certain embodiments, polymer shells have pore sizes between about 0.1 nm and about 0.5 nm. In certain embodiments, the pore size is measured by microscopy (e.g. TEM, SEM, or AFM).

The present disclosure places no particular restriction on composition of anionic functionalized polymer shells described herein. Particularly useful aspects of compositions include suitable permeability characteristics as described above as well as physical and chemical compatibility with electrolytes, active species, additives and solutes that will be encountered in electrochemical devices to which nanostructured materials are to be applied.

In certain embodiments, nanostructured materials of the present disclosure comprise electronically conductive polymers. In certain embodiments, nanostructured materials of the present disclosure comprise polymers selected from the group consisting of: polyheterocycles, poly-enes, and polyarenes. In certain embodiments, nanostructured materials of the present disclosure comprise polymers selected from the group consisting of: polyaniline, polydopamine, polypyrrole, polyselenophene, polythiophene, polynaphthalene, polyphenylene sulfide, and derivatives, mixtures or copolymers of any of these. In certain embodiments, nanostructured materials of the present disclosure comprise polymers selected from the group consisting of: polypyrrole (PPy), polythiophene (PTh), polydopamine, poly(3,4-ethylenedioxythiophene) (PEDOT), poly(3,4-propylenedioxythiophene) (ProDOT), poly(3,4-ethylenedioxypyrrole) (PEDOP), poly(3,4-propylenedioxypyrrole) (ProDOP), poly(3,4-ethylenedithiopyrrole) (PEDTP), poly(3,4-ethyleneoxyhiathiophene) (PEOTT), poly(3,4-ethylenedioxyselenophene) (PEDOSe), and derivatives, mixtures or copolymers of any of these. In certain embodiments, nanostructured materials of the present disclosure comprise polymers selected from the group consisting of: polyaniline (PAni), poly-N-methylaniline, poly(o-methylaniline) (POTO), poly(o-methoxyaniline) (POAS), poly(2,5-dimethylaniline) (PDMA), poly(2,5-dimethoxyaniline) (PDOA), sulfonated polyaniline (SPAN), poly(1-aminonaphthalene) (PNA), poly(5-aminonaphthalene-2-sulfonic acid) polyphenylene sulfide, and derivatives, mixtures or copolymers of any of these.

In certain embodiments, provided nanostructured materials comprising anion functionalized polymers are characterized in that they have a higher electronic conductivity at low voltages than nanostructures composed of a corresponding polymer without such anionic functional groups. In certain embodiments, nanostructures are characterized in that they comprise an anion-functionalized polymer having a conductivity of at least 10⁻⁴ S/cm at a potential below 2.5 volts vs. Li⁰. In certain embodiments, an electrically conductively polymer has a conductivity greater than 1×10⁻⁴ S/cm at a potential below 2.4 volts. In certain embodiments, an electrically conductively polymer has a conductivity greater than 1×10⁻⁴ S/cm at a potential below 2.3 volts. In certain embodiments, an electrically conductively polymer has a conductivity greater than 1×10⁻⁵ S/cm at a potential below 2.2 volts.

In certain embodiments, an electrically conducting polymer has a conductivity between about 10⁻³ to about 0.1 S/cm at a potential below 2.3 volts. In certain embodiments, an electrically conducting polymer has a conductivity between about 0.01 to about 0.1 S/cm at a potential below 2.3 volts. In certain embodiments, an electrically conducting polymer has a conductivity between about 0.1 to about 1 S/cm at a potential below 2.3 volts. In certain embodiments, an electrically conducting polymer has a conductivity greater than 1 S/cm at a potential below 2.3 volts.

In certain embodiments, an electrically conducting polymer has a conductivity between about 10⁻⁶ to about 0.1 S/cm at a potential below 2.2 volts. In certain embodiments, an electrically conducting polymer has a conductivity between about 10⁻⁵ to about 10⁻³ S/cm at a potential below 2.2 volts. In certain embodiments, an electrically conducting polymer has a conductivity between about 10⁻³ to about 0.01 S/cm at a potential below 2.2 volts. In certain embodiments, an electrically conducting polymer has a conductivity greater than 0.01 S/cm at a potential below 2.2 volts.

In certain embodiments, a nanostructured material comprises a composite of a polymer and an inorganic material such as, for example, metals, metal alloys, metal oxides, metal sulfides, elemental carbon, and silicon, carbon, silicon carbide. In certain embodiments, an inorganic compositing material is selected from: aluminum oxide, aluminum sulfide, silicon oxide, iron oxide, manganese oxide, titanium disulfide, molybdenum disulfide, copper sulfide, germanium disulfide, zirconium oxide, titanium oxide, and zeolites.

In another embodiment, a nanostructured material according to the present disclosure comprises a polymer with dispersed organic or inorganic matrices in the form of nano-sized powdered solids present at amounts up to 80 wt % of a polymer. Carbon matrices can be prepared by pyrolysis of any suitable material as described in U.S. Pat. No. 6,585,802. Zeolites prepared as described in U.S. Pat. No. 6,755,900 may also be used as an inorganic matrix. In at least one embodiment, matrices comprise particles less than about 50 nanometers diameter, for example less than about 40 nm, less than about 25 nm, less than about 20 nm, less than about 10 nm, less than about 5 nm, less than about 2 nm, or less than 1 nm in diameter.

In certain embodiments, a nanostructured material comprises a composite of an anionically-substituted polymer and other polymers that do not contain such anionic functional groups. In certain embodiments, a nanostructured material comprises a composite of an anionically-substituted polymer and one or more additional polymers selected from the group consisting of: polyethylene, polypropylene, polytetrafluoroethylene (PTFE), polyvinylidene difluoride (PVDF), polysulfone, polyethersulfone, polyacrylonitrile, polyamide, polyimide, polyamideimide, polyetherimide, polyether, cellulose acetate, polyaniline, polypyrrole, polyetheretherketone (PEEK), polybenzimidazole, and composites or mixtures thereof. A polymer composite comprising such polymers can be made by any technique known in the art, including in situ polymerization, solution coating, sintering, stretching, track etching, template leaching, interfacial polymerization, or phase inversion.

In certain embodiments, a nanostructured material according to the present disclosure comprises a plurality of polymer layers. In certain embodiments, a nanostructured material is a polymer shell comprising two polymer layers. In certain embodiments, a polymer shell comprises three polymer layers. In certain embodiments, one or more polymer layers in such multilayer nanostructures are not anionically-substituted.

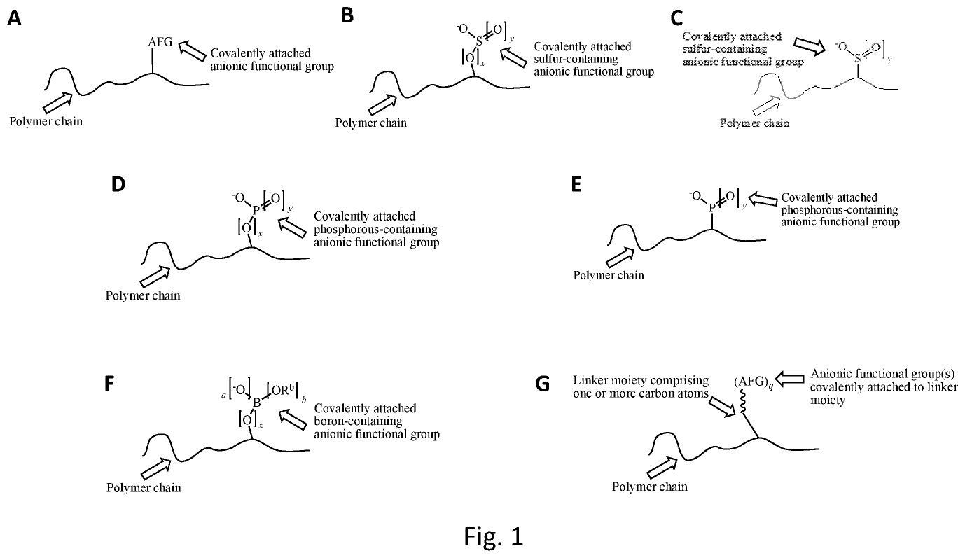

In certain embodiments, nanostructured materials of the present disclosure comprise polymers covalently bonded to one or more anionic functional groups. In certain embodiments, such polymers conform to Structure A of FIG. 1, where AFG is an anionic functional group as described herein. While only one AFG group is depicted in Structures A-G of FIG. 1, it is to be understood that polymer chains may have one or many AFG groups attached and that polymer compositions are likely to comprise statistical mixtures of polymer chains containing a distribution of different numbers of AFG groups. Similarly, location of AFG groups on a polymer chain may vary and groups may be randomly distributed, or located at specific positions (e.g. in the center or at the ends of chains).

In certain embodiments, an anionic functional group comprises one or more heteroatoms selected from the group consisting of: sulfur, selenium, nitrogen, phosphorous, tin, and boron, or combinations thereof.

In certain embodiments, nanostructured materials of the present disclosure comprise polymers covalently bonded to one or more anionic functional groups comprising sulfur. In certain embodiments such polymers conform to Structure B of FIG. 1, where x is 0 or 1, and y is 0, 1, or 2.

In certain embodiments, nanostructured materials of the present disclosure comprise polymers covalently bonded to one or more anionic functional groups comprising sulfur. In certain embodiments such polymers conform to Structure C of FIG. 1, where y is 0, 1, or 2.

In certain embodiments, nanostructured materials of the present disclosure comprise polymers covalently bonded to one or more anionic functional groups selected from the group consisting of: thiolate, sulfate, sulfonate, sulfenate, sulfinate, and combinations thereof. In certain such embodiments, a sulfur-containing anionic functional group comprises sulfonate. In certain such embodiments, a sulfur-containing anionic functional group comprises sulfinate. In certain such embodiments, a sulfur-containing anionic functional group comprises sulfate. In certain such embodiments, a sulfur-containing anionic functional group comprises thiolate.

In certain embodiments, nanostructured materials of the present disclosure comprise polymers covalently bonded to one or more anionic functional groups comprising phosphorous. In certain embodiments such polymers conform to Structure D of FIG. 1, where each of x and y is as defined above and in the genera and subgenera herein, or Structure E of FIG. 1, where y is as defined above and in the genera and subgenera herein.

In certain such embodiments, nanostructured materials of the present disclosure comprise polymers covalently bonded to a phosphorous-containing anionic functional group selected from the group consisting of: phosphate, phosphinate, phosphonate, and combinations thereof. In certain embodiments, a phosphorous-containing anionic functional group is phosphate.

In certain such embodiments, nanostructured materials of the present disclosure comprise polymers covalently bonded to one or more anionic functional groups comprising boron as in Structure F of FIG. 1, where x is as defined above; a is 0, 1 or 2; b is 0, 1, 2, or 3; the sum of a and b is 2 or 3; and R^{b} is selected from the group consisting of: optionally substituted aliphatic, optionally substituted aromatic, and another polymer chain, or where b greater than 1, two or three R^{b} can be taken together to form a cyclic boronic ester.

In certain embodiments, nanostructured materials of the present disclosure comprise polymers covalently bonded to one or more anionic functional groups selected from the group consisting of: borate, boronate, borinate, and combinations thereof. It will be appreciated that the term “borate” may refer to oxyanions as well as tetrahedral boron anions.

In certain embodiments, nanostructured materials of the present disclosure comprise polymers covalently bonded to one or more anionic functional groups through a linking moiety. Such polymers are distinguished from those described above in that an anionic functional group is not directly covalently linked to a repeating unit of a functionalized polymer, but instead is bonded to a linker moiety comprising one or more carbon atoms which is in turn covalently linked to a repeating unit in a polymer. In certain embodiments, such polymers conform to Structure G of FIG. 1, where each AFG is independently an anionic functional group as described herein, [symbol] represents a covalent linker bound to both AFG(s) and a repeat unit of a polymer chain, comprising one or more optionally substituted carbon atoms, and optionally one or more heteroatoms, and q is independently at each occurrence, an integer from 1 to 4 indicating how many AFG groups are bound to each linker moiety.

In certain embodiments, q is 1, in certain embodiments, q is 2. In certain embodiments, [symbol] is C₁₋₁₂ aliphatic. In certain embodiments, [symbol] is C₁₋₆ aliphatic. In certain embodiments, [symbol] is —CH₂—. In certain embodiments, [symbol] is optionally substituted aryl, aralkyl, or alkylaryl. In certain embodiments, [symbol] comprises one or more heteroatoms selected from N, O, and S. In certain embodiments, [symbol] comprises one or more ether linkages. In certain embodiments, [symbol] is a polyether.

In certain embodiments, nanostructured materials of the present disclosure comprise polymers covalently bonded to one or more anionic functional groups comprising tin. In certain embodiments, nanostructured materials of the present disclosure comprise polymers covalently bonded to one or more anionic functional groups comprising selenium. In certain embodiments, nanostructured materials of the present disclosure comprise polymers covalently bonded to one or more anionic functional groups comprising carboxylate.

In certain embodiments, anionic functional groups described above are present as protonated moieties. In certain embodiments, anionic functional groups described above are present as salts. In certain embodiments, anionic functional groups described above are present as salts of a metal cation. In certain embodiments, anionic functional groups are present as alkali metal salts. In certain embodiments, anionic functional groups are present as alkaline metal salts. In certain embodiments, anionic functional groups are present as transition metal salts. In certain embodiments, anionic functional groups are present as lithium salts. In certain embodiments, anionic functional groups described above are present as salts of an organic cation. In certain embodiments, anionic functional groups described above are present as salts of a nitrogen or phosphorous-containing organic cation.

In certain embodiments, the present disclosure provides nanostructured compositions comprising functionalized conductive polymers that feature functional groups introduced prior to a polymerization step. Such polymers may be obtained by performing a polymerization or oligomerization step in the presence of functionalized co-monomers. In certain embodiments, such functionalized co-monomers have structures that, upon polymerization, do not interrupt electrical conductivity of a polymer network.

In certain embodiments, the present disclosure provides nanostructured compositions comprising functionalized conductive polymers that feature anionic functional groups introduced during polymerization. Such polymers may be obtained by performing a polymerization or oligomerization step in the presence of reagents which will react with co-monomers or formed polymer in situ to afford anionic functionalization of a polymer shell (“functionalizing reagents”) such as sulfonating reagents. In such embodiments, functionalizing reagents do not interrupt formation of a polymer.

In certain embodiments, the present disclosure provides nanostructured compositions comprising functionalized conductive polymers that feature anionic functional groups introduced in a post-polymerization process. In certain embodiments, such anionic functional groups do not interrupt electrical conductivity of a polymer network.

In certain embodiments, wherein a polymer having covalently-linked anionic functional groups comprises polyaniline-which is typically synthesized from aniline in the presence of chemical oxidants or via electrochemical oxidation-suitable functionalized co-monomers include anilines substituted at ortho- or meta-positions with groups comprising anionic functional groups or precursors to anionic functional groups. In certain embodiments, such monomers conform to the formulae:

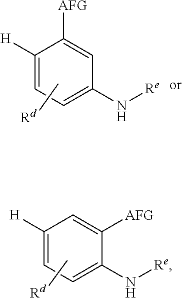

where, -AFG is an anionic functional group as defined above and in the genera and subgenera herein, and R^{d} represents one or more optionally present groups independently defined as described hereinbelow; and each —R^{e} is independently selected from the group consisting of: —H, optionally substituted phenyl and optionally substituted C₁₋₄ aliphatic.

In certain embodiments, wherein a polymer having covalently-linked anionic functional groups comprises polyaniline, a functionalized co-monomer is selected from the group consisting of:

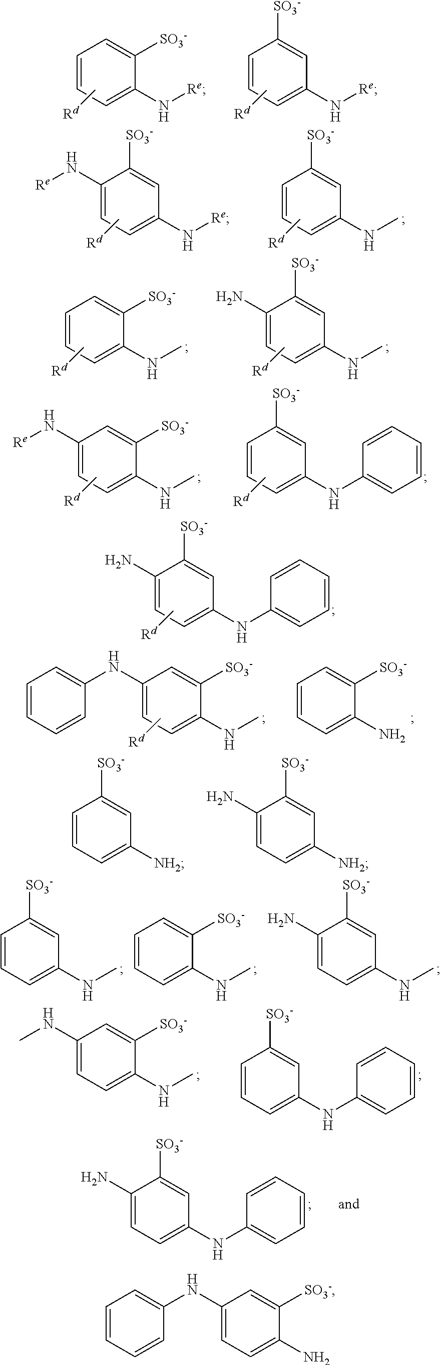

where each of R^{d} and R^{e} is as defined above and in the genera and subgenera herein.

In certain embodiments, wherein a polymer having covalently-linked anionic functional groups comprises polyaniline, a functionalized co-monomer is selected from the group consisting of:

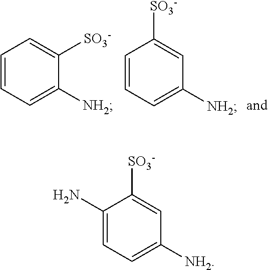

where each of R^{d} and R^{e} is as defined above and in the genera and subgenera herein.

In certain embodiments, wherein a polymer having covalently-linked anionic functional groups comprises polyaniline, a functionalized co-monomer has a formula:

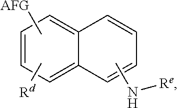

where each of AFG, R^{d} and R^{e} is as defined above and in the genera and subgenera herein.

In certain embodiments, wherein a polymer having covalently-linked anionic functional groups comprises polyaniline, a functionalized co-monomer has a formula selected from the group consisting of:

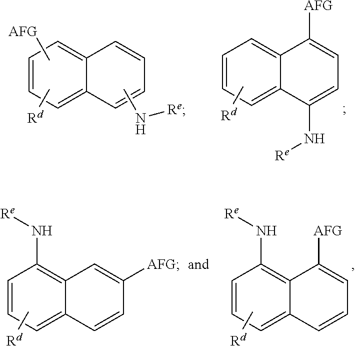

where each of R^{d}, R^{e}, and AFG is as defined above and in the genera and subgenera herein.

In certain embodiments, wherein a polymer having covalently-linked anionic functional groups comprises polyaniline, a functionalized co-monomer has a formula selected from the group consisting of:

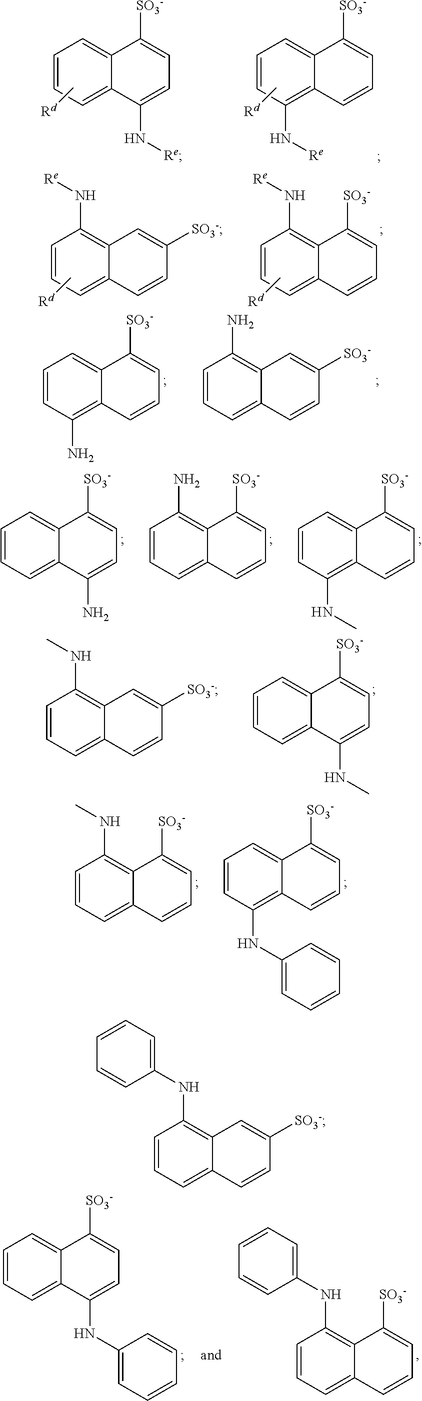

where each of R^{d}, and R^{e}, is as defined above and in the genera and subgenera herein.

In certain embodiments, suitable functionalized co-monomers include anilines substituted at ortho- or meta-positions with groups comprising linker moieties bearing anionic functional groups or precursors to anionic functional groups. In certain embodiments, such monomers conform to formulae:

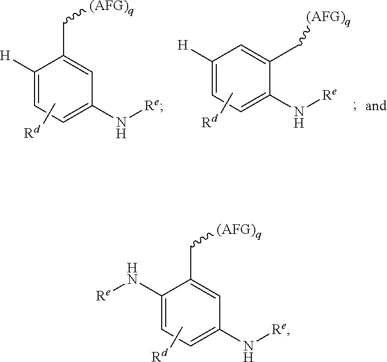

where, each of R^{d}, R^{e}, -AFG, and q as defined above and in the genera and subgenera herein.

Density of anionic functional groups in provided polymer compositions may be controlled to modulate the properties and performance characteristics of nanostructured materials described herein. For polymers formed by co-polymerization with functionalized monomers, density of functionalization can be controlled by changing molar ratio of such functionalized monomers to unsubstituted aniline, and/or by changing rate and timing of addition of such monomers to a polymerization. In certain embodiments, relatively light functionalization is desirable. In other situations, high density of functionalization may be desirable. Density of functionalization of suitable polymers advantageously ranges from about 0.01 mol % up to about 100 mol % functionalized monomer units relative to unsubstituted monomer units in a polymer.

In certain embodiments, nanostructured compositions of the present disclosure comprise lightly functionalized conductive polymer compositions containing between about 0.05 mol % and about 2 mol % enchained functionalized monomer units relative to unsubstituted monomer units enchained in a polymer. In certain embodiments, nanostructured compositions of the present disclosure comprise functionalized conductive polymer compositions containing between 0.05 mol % and 0.1 mol %, between 0.1 mol % and 0.5 mol %, between 0.5 mol % and 1 mol %, or between 1 mol % and 2 mol % enchained functionalized monomer units relative to unsubstituted monomer units enchained in a polymer. In certain embodiments, nanostructured compositions of the present disclosure comprise functionalized conductive polymer compositions containing between 1 mol % and 10 mol %, between 5 mol % and 15 mol %, between 10 mol % and 20 mol %, or between 15 mol % and 30 mol % enchained functionalized monomer units relative to unsubstituted monomer units enchained in a polymer. In certain embodiments, nanostructured compositions of the present disclosure comprise functionalized conductive polymer compositions containing more than 30 mol % enchained functionalized monomer units relative to unsubstituted monomer units enchained in the polymer. In certain embodiments, nanostructured compositions of the present disclosure comprise functionalized conductive polymer compositions containing more than 40 mol %, more than 50%, more than 60%, more than 70%, or more than 80% enchained functionalized monomer units relative to unsubstituted monomer units enchained in a polymer. In certain embodiments, nanostructured compositions of the present disclosure comprise functionalized conductive polymer compositions containing essentially only monomer units functionalized with anionic functional groups.

For applications described herein, distribution of anionic functional groups in provided conductive polymer compositions may be important in modulating performance characteristics. In certain embodiments, spatial distribution of functional groups on polymer chains can be controlled. In certain embodiments, spatial distribution is controlled by first synthesizing oligomers of a functionalized or unsubstituted monomer (e.g., substituted or unsubstituted aniline) to form linear chains of a desired length (e.g., oligomers in the range of a few repeat units to small polymers containing up to about 50 repeat units) prior to introducing a second monomer with a differing substitution pattern. In certain embodiments, this process can be performed in one pot without isolation of the initially prepared oligomer prior to reaction with secondary monomers. In other cases, it may be advantageous or convenient to produce and isolate the initially prepared oligomer prior to feeding them into a polymerization containing secondary monomers.

### C. Polymers—Functionalized Repeating Units

Among non-heterocyclic conductive polymers, two subcategories of polymer chain structure can be used: polymers with electrical conductivity arising from extended conjugated pi systems formed from carbon-only chains comprising olefins or aryl rings such as polyacetylene and polyphenylene, and those containing conjugated pi systems including redox-active heteroatoms, particularly nitrogen and sulfur, which contribute to chain conductivity. In certain embodiments, conductive polymers containing redox-active heteroatoms used in accordance with the present disclosure comprise repeating units having a formula M1:

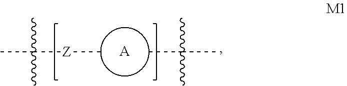

wherein:
Z is, independently at each occurrence in the polymer chain, selected from the group consisting of —N═, —NR—, —S—, and cations, radicals, radical cations or protonated versions of any of these, where R, at each occurrence is independently selected from the group consisting of —H, and a C₁₋₄ aliphatic radical;
each dashed bond may, independently at each occurrence in the polymer chain, be a single bond or a double bond in conformance with the valences and charges of the atoms connected by such bond(s); and
\textcircled{A} is a non-heterocyclic aromatic moiety, where each \textcircled{A} may be the same or different at each occurrence in the polymer chain.

In certain embodiments, polymers of the present disclosure comprise repeating units (e.g., monomer units) of formula M1, where Z is or comprises a nitrogen atom. In some embodiments, Z is —N═. In certain embodiments, Z is —NR—. In certain embodiments, Z is —NH—. In certain embodiments, Z is independently at each occurrence in a polymer chain selected from the group consisting of —N— and —NR—.

In certain embodiments, M1 is selected from the group consisting of:

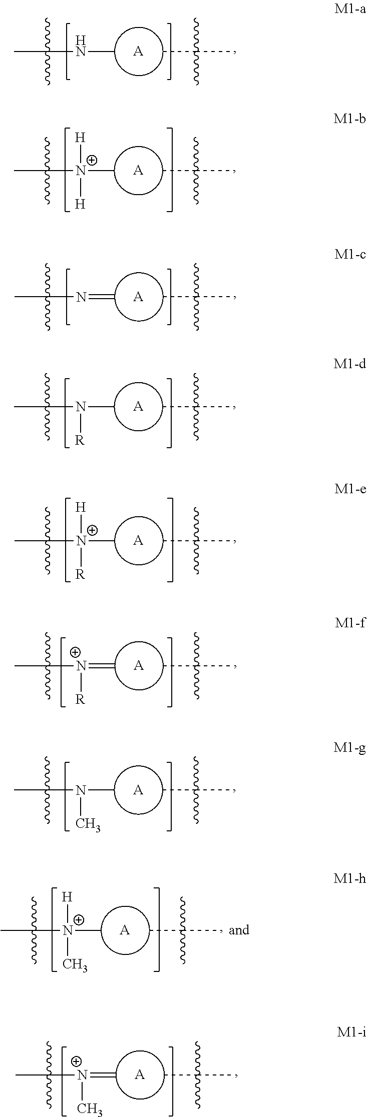

or a combination thereof.

In certain embodiments, provided polymers comprise monomer units of formula M1-a:

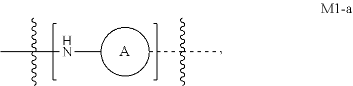

where \textcircled{A} is as defined above and described in the genera and subgenera herein.

In certain embodiments, provided polymers comprise monomer units of formula M1-b:

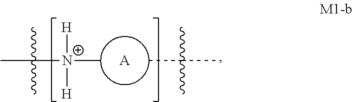

where \textcircled{A} is as defined above and described in the genera and subgenera herein.

In certain embodiments, Z is a nitrogen atom and R is absent. In certain embodiments, provided polymers comprise monomer units of formula M1-c:

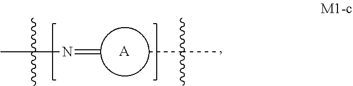

where is as defined above and described in the genera and subgenera herein.

In certain embodiments, provided polymers comprise monomer units of formula M1-d:

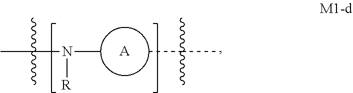

where R and \textcircled{A} are each as defined above and described in the genera and subgenera herein.

In certain embodiments, provided polymers comprise monomer units of formula M1-e:

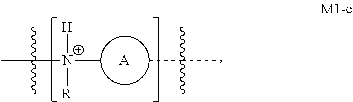

where R and \textcircled{A} Dare each as defined above and described in the genera and subgenera herein.

In certain embodiments, provided polymers comprise monomer units of formula M1-f:

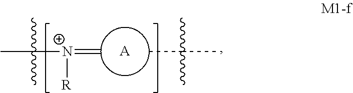

where R and \textcircled{A} Dare each as defined above and described in the genera and subgenera herein.

In certain embodiments, provided polymers comprise monomer units of formula M1-g:

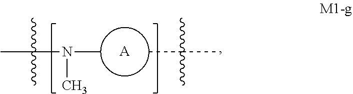

where \textcircled{A} is as defined above and described in the genera and subgenera herein.

In certain embodiments, provided polymers comprise monomer units of formula M1-h:

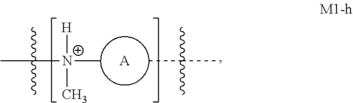

where is as defined above and described in the genera and subgenera herein.

In certain embodiments, provided polymers comprise monomer units of formula M1-i:

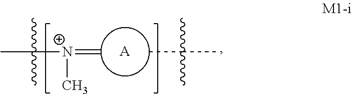

where \textcircled{A} is as defined above ad described in the genera an subgenera herein.

In certain embodiments, a polymer comprises subunits (e.g., repeating units) of a formula selected from the group consisting of:

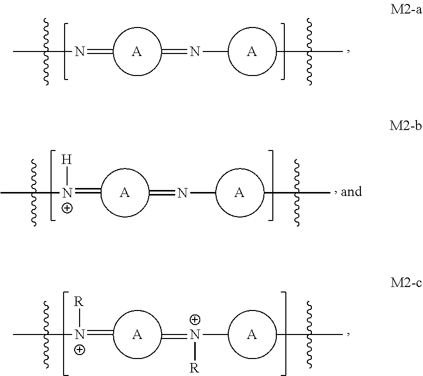

or a combination thereof.

In certain embodiments, provided polymers comprise subunits of formula M2-a:

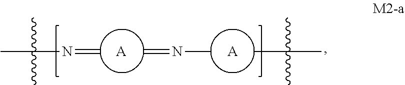

where is as defined above and described in the genera and subgenera herein.

In certain embodiments, provided polymers comprise subunits of formula M2-b:

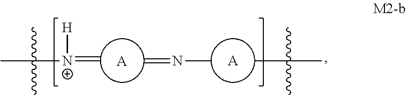

where is as defined above and described in the genera and subgenera herein.

In certain embodiments, provided polymers comprise subunits of formula M2-c:

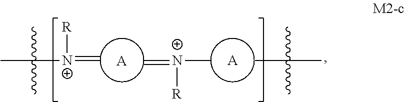

where R and \textcircled{A} are each as defined above and described in the genera and subgenera herein.

In certain embodiments, provided polymers comprise subunits of formula M2-d:

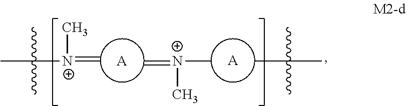

where \textcircled{A} is as defined above and described in the genera and subgenera herein.

In certain embodiments, polymers of the present disclosure comprise a combination of any two or more of the repeating units M1-a through M1-i and M2-a through M2-c. In certain embodiments, polymers of the present disclosure comprise a combination of M1-a and M1-c. In certain embodiments, polymers of the present disclosure comprise a combination of M1-a and M2-a. In certain embodiments, polymers of the present disclosure comprise a combination of M2-a and M2-c. In certain embodiments, polymers of the present disclosure comprise a combination of M1-d and M2-c. In certain embodiments, polymers of the present disclosure comprise a combination of M1-g and M2-d.

In certain embodiments, \textcircled{A} comprises an optionally substituted phenylene. In certain embodiments, \textcircled{A} comprises an optionally substituted polycyclic aromatic moiety. In certain embodiments, \textcircled{A} is selected from the group consisting of optionally substituted phenylene, naphthylene, and biphenylene.

In certain embodiments, at least a subset of \textcircled{A} are independently selected from the group consisting of:

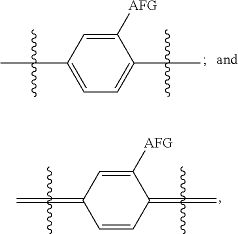

wherein -AFG is or comprises an anionic functional group as defined above and in the genera and subgenera herein.

In certain embodiments, one or more -AFG is a sulfur-, selenium-, phosphorous-, tin-, or boron-containing functional group.

In certain embodiments, -AFG comprises a sulfur-containing functional group. In certain such embodiments, one or more -AFG is selected from the group consisting of: thiolate, sulfate, sulfonate, sulfenate, and sulfinate. In certain such embodiments, -AFG comprises sulfonate.

In certain embodiments, one or more -AFG comprises a phosphorous-containing functional group. In certain such embodiments, one or more -AFG is selected from the group consisting of: phosphate and phosphonate.

In certain embodiments, one or more -AFG is selected from the group consisting of: boronate, stannate, and selenate.

In certain embodiments, one or more -AFG is or comprises carboxylate.

In certain embodiments, each \textcircled{A} independently has the formula:

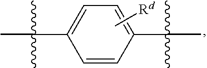

wherein:
R^{d} may be present or absent and when present may be present at one or more than one substitutable position on the ring each being independently selected at each occurrence from the group consisting of: a covalent interchain linking group, a halogen atom, -AFG, —OR, —OC(O)R, —OCO₂R, —OC(O)N(R)₂, —OCN, —OSi(R)₃, —CO₂R, —C(O)N(R)₂, —C(N)N(R)₂, —CN, —C(S)OR, —C(S)SR, —C(S)N(R)₂, —N(R)₂, —NRC(O)R, —NRCO₂R, —NRC(O)N(R)₂, —NRC(N)R, —NRC(N)N(R)₂, —N⁺(R)₃, —NRSO₂R, —NCO, —NO₂, —N₃, —NROR, —SR, —SR, —S⁺(R)₂, —SO₂R, —SOR, —SO₂N(R)₂, —SC(O)SR, —SC(S)SR, —Si(R)₃, or an optionally substituted radical selected from the group consisting of C₁₋₂₀ aliphatic; C₁₋₂₀ heteroaliphatic; phenyl; a 3- to 8-membered saturated or partially unsaturated monocyclic carbocycle, a 7-14 carbon saturated, partially unsaturated or aromatic polycyclic carbocycle; a 5- to 6-membered monocyclic heteroaryl ring having 1-4 heteroatoms independently selected from nitrogen, oxygen, or sulfur; a 3- to 8-membered saturated or partially unsaturated heterocyclic ring having 1-3 heteroatoms independently selected from nitrogen, oxygen, or sulfur; a 6- to 12-membered polycyclic saturated or partially unsaturated heterocycle having 1-5 heteroatoms independently selected from nitrogen, oxygen, or sulfur; or an 8- to 10-membered bicyclic heteroaryl ring having 1-5 heteroatoms independently selected from nitrogen, oxygen, or sulfur; where two or more R^{d} groups may be taken together with intervening atoms to form one or more optionally substituted rings optionally containing one or more heteroatoms,
R at each occurrence is independently hydrogen, an optionally substituted radical selected the group consisting of C₁₋₁₆ acyl; C₁₋₆ aliphatic; C₁₋₆ heteroaliphatic; carbamoyl; arylalkyl; phenyl; a 3- to 8-membered saturated or partially unsaturated monocyclic carbocycle; a 7- to 14-membered saturated, partially unsaturated or aromatic polycyclic carbocycle; a 5- to 6-membered monocyclic heteroaryl ring having 1-4 heteroatoms independently selected from nitrogen, oxygen, or sulfur; a 3- to 8-membered saturated or partially unsaturated heterocyclic ring having 1-3 heteroatoms independently selected from nitrogen, oxygen, or sulfur; a 6- to 12-membered polycyclic saturated or partially unsaturated heterocycle having 1-5 heteroatoms independently selected from nitrogen, oxygen, or sulfur; or an 8- to 10-membered bicyclic heteroaryl ring having 1-5 heteroatoms independently selected from nitrogen, oxygen, or sulfur; an oxygen protecting group; and a nitrogen protecting group, where two R groups on the same nitrogen atom can optionally be taken together to form an optionally substituted 3- to 7-membered ring;
wherein at least a subset of \textcircled{A} comprise an -AFG group.

In certain embodiments, at least a subset of \textcircled{A} are independently selected from the group consisting of:

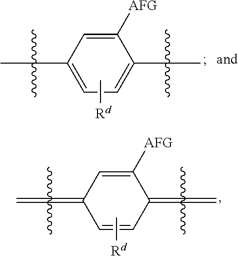

where each -AFG and —R^{d} is as defined above and described in the genera and subgenera herein. In certain embodiments, R^{d} is C₁₋₄ aliphatic. In certain embodiments, R^{d} is methyl. In certain embodiments, R^{d} is halogen. In certain embodiments, R^{d} is a nitro group. In certain embodiments, R^{d} is C₁₋₆ alkoxy. In certain embodiments, R^{d} is methoxy. In certain embodiments, two R^{d} are taken together to form a fused phenyl ring (i.e. a naphthyl ring).

In certain embodiments, at least a subset of \textcircled{A} are independently selected from the group consisting of:

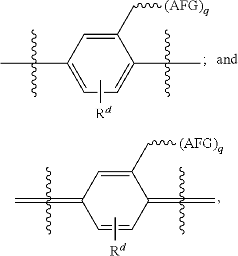

where each -AFG, —R^{d}, [symbol] , and is as defined above and described in the genera and [symbol] subgenera herein. In certain embodiments, R^{d} is C₁₋₄ aliphatic. In certain embodiments, R^{d} is methyl. In certain embodiments, R^{d} is halogen. In certain embodiments, R^{d} is a nitro group. In certain embodiments, R^{d} is C₁₋₆ alkoxy. In certain embodiments, R^{d} is methoxy. In certain embodiments, two R^{d} are taken together to form a fused phenyl ring (i.e. a naphthyl ring). In certain embodiments, [symbol] is methylene.

In certain embodiments, a polymer comprises a mixture of repeat units (e.g., \textcircled{A}) that are substituted with anionic functional groups and repeat units (e.g., \textcircled{A}) that are not substituted with anionic functional groups. In certain embodiments, the ratio of repeat units comprising anionic functional groups to repeat units not comprising anionic functional groups is between about 1:10 and about 10:1. In certain embodiments, the ratio of repeat units comprising anionic functional groups to repeat units not comprising anionic functional groups is between about 1:2 and about 2:1. In certain embodiments, the ratio of repeat units comprising anionic functional groups to repeat units not comprising anionic functional groups is between about 1:10 and about 10:1.

In certain embodiments, the ratio of repeat units comprising anionic functional groups to repeat units not comprising anionic functional groups is greater than about 1:10. In certain embodiments, the ratio of repeat units comprising anionic functional groups to repeat units not comprising anionic functional groups is greater than about 1:5. In certain embodiments, the ratio of repeat units comprising anionic functional groups to repeat units not comprising anionic functional groups is greater than about 1:4. In certain embodiments, the ratio of repeat units comprising anionic functional groups to repeat units not comprising anionic functional groups is greater than about 1:3. In certain embodiments, the ratio of repeat units comprising anionic functional groups to repeat units not comprising anionic functional groups is greater than about 1:2. In certain embodiments, the ratio of repeat units comprising anionic functional groups to repeat units not comprising anionic functional groups is greater than about 1:1. In certain embodiments, the ratio of repeat units comprising anionic functional groups to repeat units not comprising anionic functional groups is greater than about 2:1. In certain embodiments, the ratio of repeat units comprising anionic functional groups to repeat units not comprising anionic functional groups is greater than about 3:1. In certain embodiments, the ratio of repeat units comprising anionic functional groups to repeat units not comprising anionic functional groups is greater than about 4:1. In certain embodiments, the ratio of repeat units comprising anionic functional groups to repeat units not comprising anionic functional groups is greater than about 5:1.

The molar percentage of repeat units comprising anionic functional groups relative to other repeat units can be measured in a polymer composition by spectroscopic analysis of a polymer by known methods—for example, utilizing techniques such as nuclear magnetic resonance spectroscopy or infrared spectroscopy to measure intensity of spectroscopic signals associated with anionic functional groups or atoms bonded to such groups. Alternatively, a mole percent of repeat units comprising anionic functional groups can be inferred from knowledge of monomer feed ratios utilized in a polymerization process, or by other means known in the art.

### D. Contained Electroactive Substance

As described above, in certain embodiments, in addition to anion-functionalized polymer compositions described above, nanostructured materials of the present disclosure comprise electroactive substances. In certain embodiments, such electroactive substances have a morphology controlled by a nanostructured polymeric material. In certain embodiments, an electroactive substance is contained within an enclosed volume that is separated from space outside of a nanostructured material by a structure comprising the anion-functionalized polymer. In certain embodiments, an electroactive substance is contained in a shell comprising an anion-functionalized polymer.

Such electroactive substances undergo electrochemical reactions and provide electrical capacity to devices fabricated from provided nanostructured materials. These substances are referred to generically herein as ‘contained electroactive materials’. In certain embodiments, provided nanostructured materials comprise solid electroactive materials, which are contained within an enclosed volume. In certain embodiments, a contained electroactive material may be a liquid or may be dissolved in a liquid phase.

In embodiments where contained electroactive materials are solids, they may be referred to generically as ‘contained electroactive solids’. Such solids have a composition different from a solid substance(s) comprising a polymer shell of nanostructured materials. No specific limitations are placed on shape of such contained electroactive solids or their distribution within a nanostructured material. In certain embodiments, an electroactive solid is contained within a particle. In certain embodiments, an electroactive solid is partially or wholly separated from a nanostructured material in which it is contained (i.e. as a yolk in a yolk shell nanoparticle). In certain embodiments, a contained electroactive substance is in physical contact or is wholly or partially adhered to a nanostructured material. In certain embodiments, a contained electroactive substance is present as a coating on a surface of a nanostructured material. It is noteworthy that electroactive solids may be produced or manufactured with a particular shape or arrangement within a nanostructured material, but that these may change during operation (e.g. charge or discharge) of an electrochemical device comprising an electroactive material.

In certain embodiments, a contained electroactive solid is present in a form having at least one dimension with a length in the range of about 5 nm to about 3,000 nm. In certain embodiments, a contained electroactive solid is present in a form having at least one dimension with a length in the range of about 10 nm to about 50 nm, about 30 nm to about 100 nm, about 100 nm to about 500 nm, or about 500 nm to about 1000 nm. In certain embodiments, a contained electroactive solid is present in a form having at least one dimension with a length in the range of about 1000 nm to about 1500 nm, about 1000 nm to about 2000 nm, about 1500 nm to about 3000 nm, or about 2000 nm to about 3000 nm.

In certain embodiments, a contained electroactive material comprises sulfur and nanostructured materials have utility as cathode materials for sulfur batteries. Such compositions comprise an electroactive sulfur-based material. Examples of suitable electroactive sulfur materials include elemental sulfur; sulfur-containing organic molecules, sulfur-containing polymers, sulfur-containing composites; or metal sulfides as well as combinations or composites of two or more of these. In certain embodiments, an electroactive sulfur material is selected from the group consisting of: elemental sulfur, lithium sulfide, and a sulfur-containing polymer, or combinations thereof.

In certain embodiments, an electroactive sulfur is present in the form of elemental sulfur. In certain embodiments, an electroactive sulfur material comprises S₈.

In certain embodiments, an electroactive sulfur is present as a metal sulfide. In certain embodiments, a metal sulfide comprises an alkali metal sulfide; in certain embodiments, a metal sulfide comprises lithium sulfide.

In certain embodiments, an electroactive sulfur material is present as a composite with another material. Such composites may include materials such as graphite, graphene, graphene oxide, carbon nanotubes, metals, metal alloys, metal sulfides or oxides, polymers, or conductive polymers. In certain embodiments, sulfur may be alloyed with other chalcogenides such as selenium or arsenic.

Generally, dimensions and shape of an electroactive sulfur-based material in a cathode composition may be varied to suit a particular application and/or be controlled as a result of morphology of a nanostructure comprising electroactive sulfur. In various embodiments, an electroactive sulfur-based material is present as a nanoparticle. In certain embodiments, such electroactive sulfur-based nanoparticles have a spherical or spheroid shape. In certain embodiments, nanostructured materials of the present disclosure comprise substantially spherical sulfur-containing particles with a diameter in the range of about 50 nm to about 1200 nm. In certain embodiments, such particles have a diameter in the range of about 50 nm to about 250 nm, about 100 nm to about 500 nm, about 200 nm to about 600 nm, about 400 nm to about 800 nm, or about 500 nm to about 1000 nm.

Such nanoparticles may have various morphologies as described above. In certain embodiments, an electroactive sulfur-based material is present as a core of a core-shell particle, where it is surrounded by a selectively permeable shell comprising an anion-substituted polymer as described herein. In certain embodiments, such core-shell particles may comprise yolk-shell particles as described above.

### II. METHODS

In another aspect, the present disclosure provides methods of manufacturing provided nanostructured materials. The art of nanomaterial synthesis and engineering is well advanced and the skilled artisan will be familiar with bountiful literature teaching methods to make nano-sized structures suitable for application in the current disclosure, including methods for making materials where an electroactive substance is contained within a volume defined by a nanostructure. Nanostructured materials of the present disclosure may be produced by combining these methods with specific steps and strategies described herein to control functionalization of polymers composing such nanostructures. Among other things, the present disclosure provides methods to achieve these ends.

Anionic functional groups may be introduced into a polymer either prior to introduction of an electroactive substance, during coating of an electroactive substance, or by functionalization post-formation of a nanostructured material. In certain embodiments, functional groups are present in conductive polymer compositions during a polymerization step. Such polymers may be obtained by performing a polymerization or oligomerization step in the presence of monomers comprising anionic functional groups (or precursors (e.g., protonated forms) thereof). For example, sulfonated aniline can be used as a monomer (or co-monomer with aniline) in polymerization of polyaniline. It is believed to be important, but likely not critical, that functional groups introduced during a polymerization stage do not interfere with or participate in a polymerization process.

In certain embodiments, the present disclosure relates to a method for fabricating a nanostructured material, comprising a polymer and an electroactive sulfur composition, wherein a polymer is electrically conducting and has a structure comprising one or more anionic functional groups covalently bound to a polymer and a method comprises a step of polymerizing a monomer under conditions that lead to concomitant functionalization of a polymer with anionic functional groups or a precursor of such anionic functional groups.

In certain embodiments, provided functionalized conductive polymer compositions contain anionic functional groups introduced by treating a polymer composition with a functionalizing agent in a post-polymerization process. Subsequently treating a polymer composition in a post-polymerization process effects a modification of functional groups. In principle, a wide range of chemistries can be utilized to make such polymer compositions.

In certain embodiments, the present disclosure relates to a method for fabricating a nanostructured material comprising a polymer and an electroactive sulfur composition, wherein a polymer is electrically conducting and has a structure comprising one or more anionic functional groups covalently bound to a polymer, wherein a method comprises a step of polymerizing a monomer not containing anionic functional groups to form a polymer and a subsequent step of modifying a polymer in a post-polymerization step to introduce anionic functional groups. In certain embodiments, a post-polymerization step comprises sulfonating a polymer.

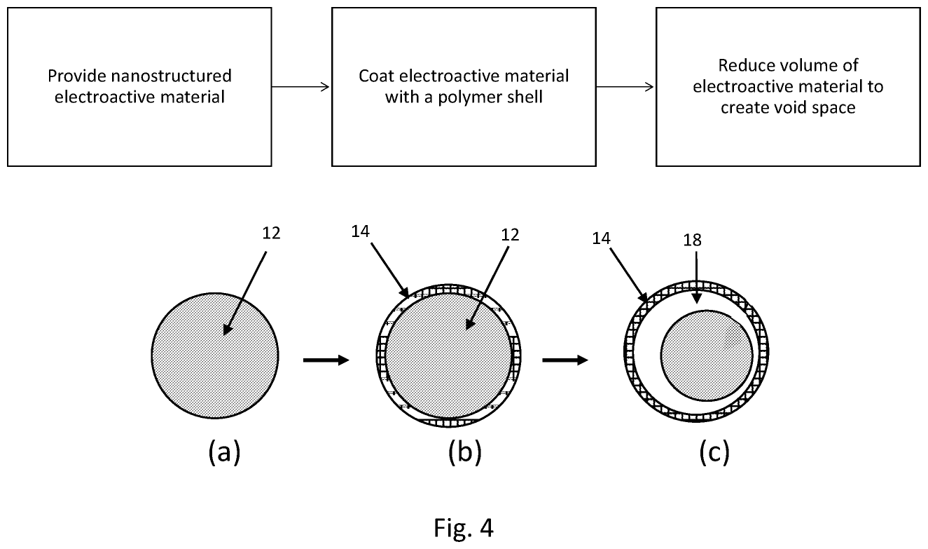

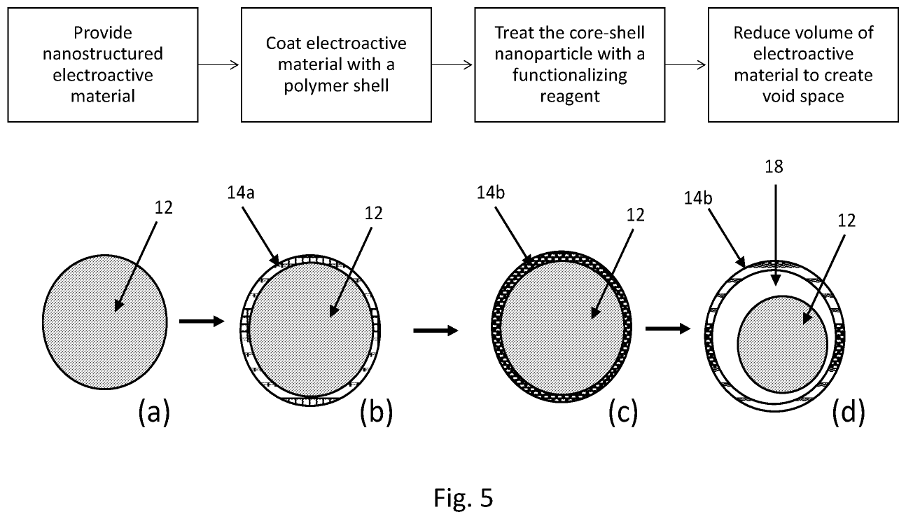

FIGS. 4 and 5 depict methods of manufacturing core-shell and yolk-shell nanoparticles in accordance with one or more embodiments of the present disclosure.

One approach to producing nanostructured materials, illustrated in FIG. 4, comprises the following steps:
a) providing a nanostructured electroactive material 12;
b) contacting the nanostructured electroactive material with a polymerization mixture, comprising a mixture of co-monomers, under conditions that promote polymerization to produce a conductive polymer shell 14 (e.g., any of the conductive polymer compositions described hereinabove); and
c) optionally reducing the volume of the electroactive material to create a void space 18.

The approach depicted in FIG. 4 can be used to produce core-shell and yolk-shell sulfur nanoparticles with functionalized PAni shells. In certain embodiments, a method of producing nanostructured materials may comprise steps of: providing an elemental sulfur nanoparticle; suspending the sulfur nanoparticle in a dilute aqueous acid solution (e.g. dilute sulfuric acid) containing aniline, and aniline substituted with an anionic functional group (or a precursor to such a group); adding to the suspension an oxidant (e.g. potassium peroxidisulfate); stirring the mixture for a period of time sufficient to form the polymer shell; and heating the nanoparticle under vacuum to remove a portion of the elemental sulfur core to provide a yolk-shell nanoparticle comprising a functionalized (e.g., anionic functionalized) PAni shell, surrounding a sulfur containing yolk, and a void space. Alternatively, a functionalized PAni coated sulfur core-shell nanoparticle depicted in FIG. 4 (b) is isolated and extracted with a solvent such as toluene that is capable of dissolving sulfur to provide a yolk-shell particle. Additionally, a core-shell nanoparticle provided in step (b) can itself, have utility in formulation of cathode mixtures and manufacture of electrochemical devices.

Another approach to producing nanostructured materials, wherein a conductive polymer shell is functionalized with anionic groups in a post-polymerization process, illustrated in FIG. 5, comprises the following steps:
a) providing a nanostructured electroactive material 12;
b) coating the nanostructured electroactive material with a polymer shell 14a by
   i) contacting the nanostructured electroactive material with a polymerization mixture comprising a mixture of co-monomers under conditions that promote polymerization to produce a conductive polymer shell 14a (e.g., any of the conductive polymer compositions described hereinabove); or
   ii) contacting the nanostructured electroactive material with pre-formed polymer under conditions that promote coating of the nanoparticle by the polymer to for the conductive polymer shell 14a;
c) treating the core-shell nanoparticle with a functionalizing reagent to provide a core-shell nanoparticle surrounded by a functionalized conductive polymer shell 14b comprising anionic functional groups; and
d) optionally reducing the volume of the electroactive material to create a void space 18.

The molar ratio of anionic functional groups introduced into a polymer can be controlled by modulating molar ratio of a functionalizing reagent to polymer repeat units (e.g., \textcircled{A}).

The approach depicted in FIG. 5 can be used to produce core-shell and yolk-shell sulfur nanoparticles with functionalized PAni shells. In certain embodiments, a method depicted in FIG. 5 may comprise the steps of: providing an elemental sulfur nanoparticle; suspending the sulfur nanoparticle in a dilute aqueous acid solution (e.g. dilute sulfuric acid) of aniline; adding to the suspension an oxidant (e.g., potassium peroxidisulfate); and stirring the mixture for a period of time sufficient to form polyaniline. This results in formation of a core-shell nanoparticle as shown in (b) which comprises an elemental sulfur core surrounded by a PAni shell. A PAni-coated particle can itself, have utility in formulation of cathode mixtures and manufacture of electrochemical devices, or it can be isolated and then contacted with a functionalizing agent to provide a nanoparticle in (c) which comprises a functionalized PAni shell 14b, surrounding sulfur-containing core 12. A core-shell particle can be treated as described above with respect to FIG. 4, to remove a portion of a sulfur core and create a yolk-shell nanoparticle.

In the processes depicted in FIGS. 4 and 5, wherein a nanostructured electroactive material comprises sulfur, the step of converting a core-shell nanoparticle to a yolk-shell nanoparticle can encompass any means of achieving desired reduction in volume of an electroactive core. In certain embodiments, such means may include: i) treating a core-shell nanoparticle with vacuum and/or heat or vaporize a portion of a sulfur-containing core; ii) treating a core-shell nanoparticle with a solvent to dissolve a portion of a sulfur-containing core; iii) treating a core-shell nanoparticle with a chemical reagent to react with and decompose a portion of the sulfur-containing core; iv) treating a composite sulfur-containing core with a solvent or reagent that dissolves or reacts with a portion of a composite; and v) combinations of any two or more of these. In certain embodiments, a core-shell particle is formed in a state where an electroactive sulfur-containing core has a maximum volume during a change of volumes resulting from changes in a charge state of the electroactive material. An example would be where the initially-formed core-shell particle (e.g., that shown in FIG. 4 (b) or FIG. 5 (c)) comprises an alkali metal sulfide such as Li₂S or Na₂S. In these embodiments, conversion from a core-shell structure to a yolk-shell structure would be effected by electrochemically converting the core to a more oxidized sulfur compound (e.g. S₈, or a polysulfide) with a lower molar volume. In certain embodiments, this step can be performed during manufacture of core-shell nanoparticles, or during a subsequent step required to manufacture or use an electrochemical device incorporating core-shell particles. For example, transformation from a core-shell particle to the yolk-shell particle could take place during charging of a manufactured battery incorporating a provided core-shell particle in a cathode composition.

While FIGS. 4 and 5 illustrate spherical core-shell particles, it will be recognized that a similar process can be utilized for electroactive substances having other morphologies (e.g. an electroactive nanowire, nano-scale platelet or the like could be substituted for the nanosphere) to provide other structured nanomaterials with similar operational characteristics.

In certain embodiments, the present disclosure relates to a method for fabricating a nanostructured material comprising a polymer and an electroactive sulfur composition, wherein a polymer is electrically conducting and has a structure comprising one or more anionic functional groups covalently bound to a polymer; a method comprising a step of polymerizing a monomer comprising anionic functional groups or a precursor to anionic functional groups. In certain embodiments, a monomer comprising anionic functional groups comprises sulfonated aniline. In certain embodiments, a monomer comprising anionic functional groups or functional group precursors is copolymerized with a monomer not containing anionic functional groups or functional group precursors. In certain embodiments, a monomer not containing anionic functional groups or functional group precursors comprises aniline.

While the present disclosure has been primarily described with respect to PAni-based shells, alternative categories of conductive polymers are contemplated and considered within the scope of the invention. Such alternatives include polyheterocycles, such as polythiophenes, polypyrrole, poly(3,4-ethylenedioxythiophene) (PEDOT), poly(3,4-ethylenedioxypyrrole) (PEDOP), as well conductive poly-enes and polyarenes (e.g., polystyrene sulfonate). Polymer shells are preferably conductive within the operating voltage range of Li/S batteries (e.g., 1.5-2.4 V). For structures of additional conductive polymers, refer to Synthesis, processing and material properties of conjugated polymers, Polymer, Vol. 37, No. 22, pp. 5017-5047, 1996, the entire disclosure of which is incorporated by reference herein.

### III. MIXTURES AND ELECTRODE COMPOSITIONS

As mentioned above, nanostructured materials of the present disclosure have utility in manufacture of electrochemical devices. Generally, nanostructured materials disclosed herein would be physically combined with other materials to create formulated mixtures which have utility for manufacture of electrodes for electrochemical devices and, in particular, mixtures useful for forming cathodes in secondary lithium batteries. In one aspect, the present disclosure provides such cathode compositions (e.g., mixtures). Typically, provided mixtures will include one or more of the nanostructured materials described hereinabove (e.g., core-shell particles, etc.), in addition to additives such as electrically conductive particles, binders, and other functional additives typically found in battery cathode mixtures. Generally, provided cathode mixtures include plentiful conductive particles to increase electrical conductivity of a cathode and provide a low resistance pathway for electrons to access a manufactured cathode. In various embodiments, other additives may be included to alter or otherwise enhance a cathode produced from the mixture. Generally, such mixtures will comprise at least 50 wt. % of a nanostructured material. In certain embodiments, such mixtures comprise at least about 60 wt. %, at least about 75 wt. %, at least about 80 wt. %, at least about 85 wt. %, or at least about 90 wt. % of a nanostructured material. In certain embodiments, such mixtures will comprise about 50 to about 90% of a nanostructured material. In certain embodiments, such mixtures will comprise about 60 to about 90% of a nanostructured material. In certain embodiments, such mixtures will comprise about 60 to about 80% of a nanostructured material. In certain embodiments, such mixtures will comprise about 70 to about 90% of a nanostructured material. In certain embodiments, such mixtures will comprise about 75 to about 85% of a nanostructured material.

In certain embodiments, nanostructured materials are mixed with one or more electrically conductive additives (e.g., conductive carbon powders, such as carbon black, Super P®, C-NERGY™ Super C65, Ensaco® black, Ketjenblack®, acetylene black, synthetic graphite such as Timrex® SFG-6, Timrex® SFG-15, Timrex® SFG-44, Timrex® KS-6, Timrex® KS-15, Timrex® KS-44, natural flake graphite, graphene, graphene oxide, carbon nanotubes, fullerenes, hard carbon, or mesocarbon microbeads, etc.) and a binder. Typical binders include polyvinylidene fluoride, poly(vinylidene fluoride-co-hexafluoropropene) (PVDF/IFP), Polytetrafluoroethylene (PTFE), Kynar Flex® 2801, Kynar® Powerflex LBG, Kynar® HSV 900, Teflon®, carboxymethylcellulose, styrene-butadiene rubber (SBR), polyethylene oxide, polypropylene oxide, polyethylene, polypropylene, polyacrylates, polyvinyl pyrrolidone, poly(methyl methacrylate), polyethyl acrylate, polytetrafluoroethylene, polyvinyl chloride, polyacrylonitrile, polycaprolactam, polyethylene terephthalate, polybutadiene, polyisoprene or polyacrylic acid, or derivatives, mixtures, or copolymers of any of these. In some embodiments, a binder is water soluble binder, such as sodium alginate or carboxymethyl cellulose. Generally, binders hold active materials together and in contact with a current collector (e.g., aluminum foil or copper foil).

In certain embodiments, provided mixtures can be formulated without a binder, which can be added during manufacture of electrodes (e.g. dissolved in a solvent used to form a slurry from a provided mixture). In embodiments where binders are included in a provided mixture, a binder can be activated when made into a slurry to manufacture electrodes.

Suitable materials for use in cathode mixtures are disclosed in Cathode Materials for Lithium Sulfur Batteries: Design, Synthesis, and Electrochemical Performance, Lianfeng, et al., Interchopen.com, Published June 1st 2016, and The strategies of advanced cathode composites for lithium-sulfur batteries, Zhou et al., SCIENCE CHINA Technological Sciences, Volume 60, Issue 2: 175-185(2017), the entire disclosures of each of which are hereby incorporated by reference herein.

In another aspect, the present invention provides novel electrode compositions comprising nanostructured materials according to the embodiments described herein. In certain embodiments, the invention provides cathode compositions. Such cathodes typically comprise a layer of electroactive material coated on a highly conductive current collector.

There are a variety of methods for manufacturing electrodes for use in a lithium battery. One process, such as a “wet process,” involves adding a positive active material (i.e., the provided nanostructured materials), a binder and a conducting material (i.e., the cathode mixture) to a liquid to prepare a slurry composition. These slurries are typically in the form of a viscous liquid that is formulated to facilitate a downstream coating operation. A thorough mixing of the slurry can be critical for the coating and drying operations, which will eventually affect the performance and quality of the electrodes. Appropriate mixing devices include ball mills, magnetic stirrers, sonication, planetary mixers, high speed mixers, homogenizers, universal type mixers, and static mixers. The liquid used to make the slurry may be any one that can homogeneously disperse the positive active material, the binder, the conducting material, and any additives, and that can be easily evaporated. Possible slurry liquids include, for example, N-methylpyrrolidone, acetonitrile, methanol, ethanol, propanol, butanol, tetrahydrofuran, water, isopropyl alcohol, dimethylpyrrolidone, and the like.

The prepared composition is coated on the current collector and dried to form the electrode. Specifically, the slurry is used to coat an electrical conductor to form the electrode by evenly spreading the slurry on to the conductor, which may then be roll-pressed (e.g. calendared) and heated as is known in the art. Generally, a matrix of the nanoparticles and conductive material are held together and on the conductor by the binder. In certain embodiments, the matrix comprises a lithium conducting polymer binder, such as polyvinylidene fluoride (PVDF), poly(vinylidene fluoride-co-hexafluoropropene) (PVDF/IFP), Polytetrafluoroethylene (PTFE), Kynar Flex® 2801, Kynar® Powerflex LBG, Kynar® HSV 900, Teflon®, styrene butadiene rubber (SBR), polyethylene oxide (PEO), and polytetrafluoroethylene (PTFE). Additional carbon particles, carbon nanofibers, carbon nanotubes, etc. may also be dispersed in the matrix to improve electrical conductivity. Additionally, lithium ions may also be dispersed in the matrix to improve lithium conductivity.

The current collector may be selected from the group consisting of: aluminum foil, copper foil, nickel foil, stainless steel foil, titanium foil, zirconium foil, molybdenum foil, nickel foam, copper foam, carbon paper or fiber sheets, polymer substrates coated with conductive metal, and/or combinations thereof.

Thickness of a matrix may range from a few microns to tens of microns (e.g., 2-200 microns). In one embodiment, a matrix has a thickness of 10-50 microns. Generally, increasing thickness of a matrix increases percentage of active nanoparticles to other constituents by weight, and may increase cell capacity. However, diminishing returns may be exhibited beyond certain thicknesses. In one embodiment, a film has a thickness of between 5 and 200 microns. In a further embodiment, a film has a thickness of between 10 and 100 microns.

A negative electrode (i.e., anode) contains a negative active material. A negative active material is one that can reversibly provide lithium ions. This may simply be lithium metal, or a substance that can intercalate or de-intercalate lithium atoms or ions. Intercalating materials may include carbon materials, preferably any carbon-based negative active material that is typically used for a lithium battery, such as crystalline carbon, amorphous carbon or a combination thereof. Further, the material, which can reversibly form a lithium-containing compound by reacting with lithium ions, may include tin oxide (SnO₂), titanium nitrate, silicon (Si), and the like, but not limited thereto. Lithium may be provided in the form of pure lithium or may be provided as an alloy of lithium and metal selected from the group consisting of: Na, K, Rb, Cs, Fr, Be, Mg, Ca, Sr, Ba, Ra, Al, In, and Sn. Typically, a negative electrode may also be disposed on a current collector, such as those described above.

PCT Publication Nos. WO2015/003184, WO2014/074150, and WO2013/040067, the entire disclosures of which are hereby incorporated by reference herein, describe various methods of fabricating electrodes and electrochemical cells.

### IV. ELECTROCHEMICAL CELLS

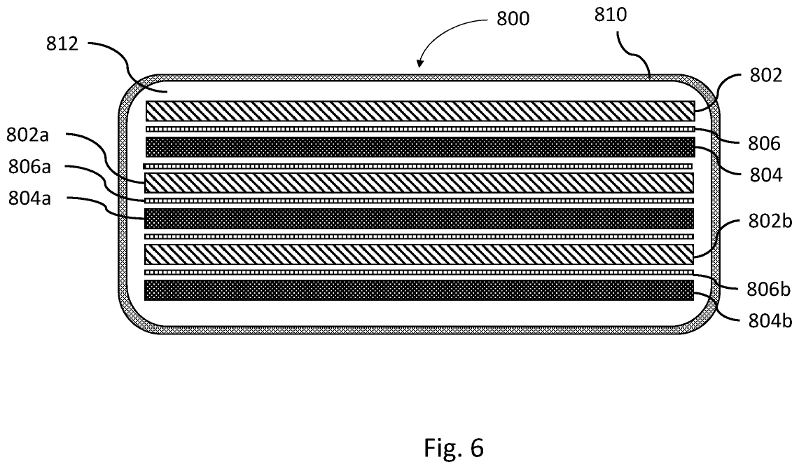

FIG. 6 illustrates a cross section of an electrochemical cell 800 in accordance with exemplary embodiments of the disclosure. Electrochemical cell 800 includes a negative electrode 802, a positive electrode 804, a separator 806 interposed between negative electrode 802 and positive electrode 804, a container 810, and a fluid electrolyte 812 in contact with negative and positive electrodes 802, 804. Such cells optionally include additional layers of electrode and separators 802a, 802b, 804a, 804b, 806a, and 806b.

Negative electrode 802 (also sometimes referred to herein as the anode) comprises a negative electrode active material that can accept cations. Non-limiting examples of negative electrode active materials for lithium-based electrochemical cells include Li metal, Li alloys such as those of Si, Sn, Bi, In, and/or Al alloys, Li₄Ti₅O₁₂, hard carbon, graphitic carbon, metal chalcogenides, and/or amorphous carbon. In accordance with some embodiments of the disclosure, most (e.g., greater than 90 wt % to all) of the anode active material can be initially included in a discharged positive electrode 804 (also sometimes referred to herein as the cathode) when electrochemical cell 800 is initially made, so that the electrode active material forms part of first electrode 802 during a first charge of electrochemical cell 800.

A technique for depositing electroactive material on a portion of negative electrode 802 is described in U.S. Patent Publication No. 2016/0172660, in the name of Fischer et al., and similarly in U.S. Patent Publication No. 2016/0172661, in the name of Fischer et al., the contents of which are hereby incorporated herein by reference, to the extent such contents do not conflict with the present disclosure.

Negative electrode 802 and positive electrode 804 can further include one or more electronically conductive additives as described above.

In accordance with some embodiments of the disclosure, negative electrode 802 and/or positive electrode 804 further include one or more polymer binders as described above.

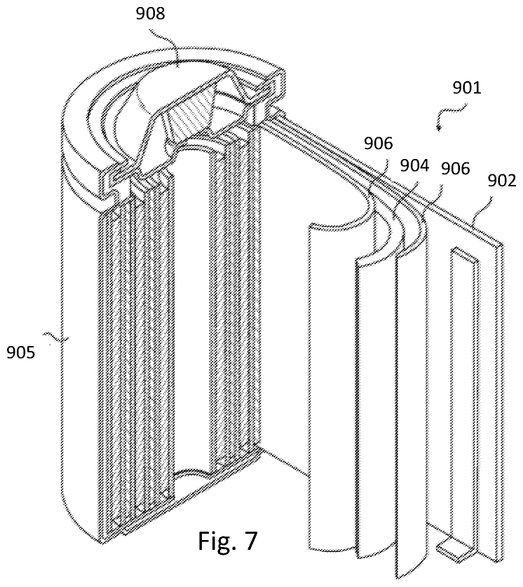

FIG. 7 illustrates an example of a battery in which the above nanostructured materials, methods, and other techniques, or combinations thereof, may be applied according to various embodiments. A cylindrical battery is shown here for illustration purposes, but other types of arrangements, including prismatic or pouch (laminate-type) batteries, may also be used as desired. The example Li battery 901 includes a negative anode 902, a positive cathode 904, a separator 906 interposed between the anode 902 and the cathode 904, an electrolyte (not shown) impregnating the separator 906, a battery case 905, and a sealing member 908 sealing the battery case 905. It will be appreciated that the example battery 901 may simultaneously embody multiple aspects of the present disclosure in various designs.

### V. EXEMPLARY EMBODIMENTS

The present disclosure contemplates, among other things, the following numbered embodiments:
Embodiment 1. A nanostructured material comprising:
   a polymer and an electroactive sulfur composition;
   wherein,
   the polymer is electrically conducting and has a structure comprising one or more anionic functional groups covalently bound to the polymer.
Embodiment 2. The nanostructured material of embodiment 1, wherein the one or more anionic functional groups contain one or more heteroatoms selected from the group consisting of: sulfur, selenium, nitrogen, phosphorous, tin, and boron, or combinations thereof.
Embodiment 3. The nanostructured material of embodiment 1, wherein at least one of the anionic functional groups comprises sulfur.
Embodiment 4. The nanostructured material of embodiment 3, wherein at least one of the anionic functional groups is selected from the group consisting of: thiolate, sulfate, sulfonate, sulfenate, and sulfinate, or combinations thereof.
Embodiment 5. The nanostructured material of embodiment 4, wherein at least one of the anionic functional groups comprises sulfonate.
Embodiment 6. The nanostructured material of embodiment 1, wherein at least one of the anionic functional groups comprises phosphorous.
Embodiment 7. The nanostructured material of embodiment 6, wherein the anionic functional group comprising phosphorous is selected from the group consisting of: phosphate and phosphonate, or combinations thereof.
Embodiment 8. The nanostructured material of embodiment 1, wherein at least one of the anionic functional groups comprises boron.
Embodiment 9. The nanostructured material of embodiment 8, wherein the anionic functional group comprising boron is selected from the group consisting of: boronate and borinate, or combinations thereof.
Embodiment 10. The nanostructured material of embodiment 1, wherein at least one of the anionic functional groups comprises tin.
Embodiment 11. The nanostructured material of embodiment 1, wherein at least one of the anionic functional groups is a carboxylate.
Embodiment 12. The nanostructured material of embodiment 1, wherein the electroactive sulfur composition is selected from the group consisting of: elemental sulfur, lithium sulfide, and a sulfur containing polymer, or combinations thereof.
Embodiment 13. The nanostructured material of embodiment 12, wherein the electroactive sulfur composition comprises elemental sulfur.
Embodiment 14. The nanostructured material of embodiment 1, wherein the electrically conducting polymer has a conductivity of at least 1×10⁻³ S/cm at a potential below 2.4 volts.
Embodiment 15. The nanostructured material of embodiment 1, wherein the electrically conducting polymer has a conductivity greater than 1×10⁻³ S/cm at a potential below 2.3 volts.
Embodiment 16. The nanostructured material of embodiment 1, wherein the electrically conducting polymer has a conductivity of about 1×10⁻⁴ to about 10⁻³ S/cm at a potential below 2.2 volts.
Embodiment 17. The nanostructured material of any one of embodiments 14 to 16, wherein the electrically conducting polymer is conductive within the range of about 1.5-2.3 volts.
Embodiment 18. The nanostructured material of any of embodiments 1-17, wherein the electrically conducting polymer comprises polyaniline.
Embodiment 19. The nanostructured material of any of embodiments 1-17, wherein the electrically conducting polymer is selected from the group consisting of a polyheterocycle, a poly-ene, or a polyarene.
Embodiment 20. The nanostructured material of embodiment 1, wherein the nanostructured material is in the form of nanoparticles.
Embodiment 21. The nanostructured material of embodiment 20, wherein the nanoparticles have a core shell morphology.
Embodiment 22. The nanostructured material of embodiment claim 21, wherein the shell comprises the electrically conducting polymer.
Embodiment 23. The nanostructured material of embodiment 21 or 22, wherein the core comprises the electroactive sulfur.
Embodiment 24. The nanostructured material of embodiment 20, wherein the nanoparticles have an average size between about 20 nm and about 1000 nm, or between about 20 and about 200 nm, or between about 150 and about 500 nm, or between about 200 and about 500 nm, or between about 400 and about 800 nm, or between about 500 and about 900 nm, or between about 700 and about 1000 nm.
Embodiment 25. The nanostructured material of any one of embodiments 20-24, wherein the nanostructured material comprises a yolk shell nanoparticle.
Embodiment 26. The nanostructured material of embodiment 25, wherein the shell comprises the electrically conducting polymer; the shell defines an interior volume, and the yolk comprises the electroactive sulfur and occupies between about 20% to about 80% of interior volume defined by the shell.
Embodiment 27. A mixture for use in the fabrication of a cathode comprising: a nanostructured material according to embodiment 1, an electrically conducting additive, and a binder.
Embodiment 28. A cathode derived from the mixture of embodiment 27.
Embodiment 29. An electrochemical cell comprising the cathode of embodiment 28.
Embodiment 30. A method for fabricating a nanostructured material,
   the material comprising a polymer and an electroactive sulfur composition;
   wherein,
      the polymer is electrically conducting and has a structure comprising one or more anionic functional groups covalently bound to the polymer;
      the method comprising a step of polymerizing a monomer comprising the anionic functional groups or a precursor to the anionic functional groups.
Embodiment 31. The method of embodiment 30, wherein the monomer comprising the anionic functional groups comprises sulfonated aniline.
Embodiment 32. The method of embodiment 30, wherein the monomer comprising anionic functional groups or functional group precursors is copolymerized with a monomer not containing anionic functional groups or functional group precursors.
Embodiment 33. The method of embodiment 32, wherein the monomer not containing anionic functional groups or functional group precursors comprises aniline.
Embodiment 34. A method for fabricating a nanostructured material,
   the material comprising a polymer and an electroactive sulfur composition;
   wherein,
      the polymer is electrically conducting and has a structure comprising one or more anionic functional groups covalently bound to the polymer;
      the method comprises a step of polymerizing a monomer not containing anionic functional groups to form the polymer and a subsequent step of modifying the polymer in a post-polymerizing step to introduce the anionic functional groups.
Embodiment 35. The method of embodiment 34, wherein the post-polymerization step comprises sulfonating the polymer.
Embodiment 36. A method for fabricating a nanostructured material,
   the material comprising a polymer and an electroactive sulfur composition;
   wherein,
      the polymer is electrically conducting and has a structure comprising one or more anionic functional groups covalently bound to the polymer;
      the method comprises a step of polymerizing a monomer under conditions that lead to concomitant functionalization of the polymer with the anionic functional groups or a precursor of such anionic functional groups.
Embodiment 37. A nanostructured material comprising:
   a polymer and an electroactive sulfur composition;
   wherein,
      the polymer comprises repeat units conforming to formula M1:

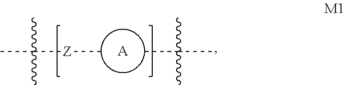

wherein:
   Z is, independently at each occurrence in the polymer chain, selected from the group consisting of —N—, —NR—, —S—, and cations, radicals, radical cations or protonated versions of any of these, where R, at each occurrence is independently selected from the group consisting of —H, optionally substituted C₁₋₄ aliphatic, and optionally substituted aryl;
   each dashed bond may, independently at each occurrence in the polymer chain, be a single bond or a double bond in conformance with the valences and charges of the atoms connected by such bond(s); and
   \textcircled{A} is a non-heterocyclic aromatic moiety, where each \textcircled{A} may be the same or different at each occurrence in the polymer chain.
Wherein at least a portion of the \textcircled{A} groups in the polymer are substituted with anionic functional groups.
Embodiment 38. The nanostructured material of embodiment 30, wherein —Z— is —N— or —NR—.
Embodiment 39. The nanostructured material of embodiment 37, wherein \textcircled{A} comprises an optionally substituted phenylene.
Embodiment 40. The nanostructured material of embodiment 38, wherein M1 is selected from the group consisting of:

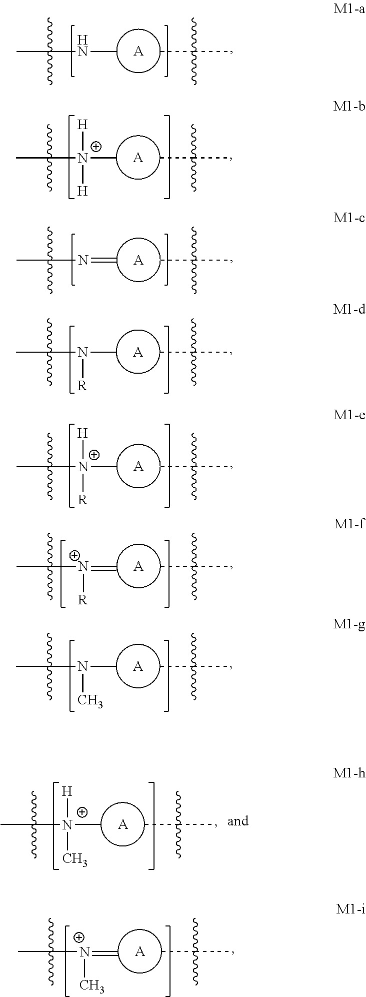

or a combination thereof.
Embodiment 41. The nanostructured material of embodiment 38, wherein the polymer comprises subunits of a formula selected from the group consisting of:

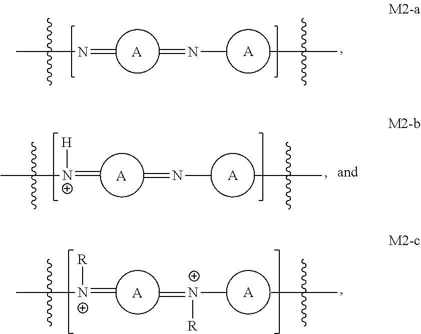

or a combination thereof.
Embodiment 42. The nanostructured material of any one of embodiments 37 to 41, wherein each is independently selected from the group consisting of:

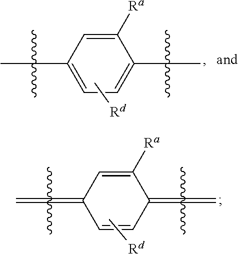

where;
   R^{a} comprises an anionic functional group, and
   R^{d} may be present or absent and when present may be present at one or more than one substitutable position on the ring, each R^{d} being independently selected at each occurrence from the group consisting of: an R^{a} group, a halogen atom, —OR, —OC(O)R′, —OCO₂R′, —OC(O)N(R′)₂, —OCN, —OSi(R)₃, —CO₂R, —C(O)N(R′)₂, —C(N)N(R′)₂, —CN, —C(S)OR′, —C(S)SR, —C(S)N(R)₂, —N(R)₂, —NRC(O)R, —NRCO₂R, —NRC(O)N(R)₂, —NRC(N)R, —NRC(N)N(R)₂, —N+(R)₃, —NRSO₂R, —NCO, —NO₂, —N₃, —NROR, —SR, —SR, —S⁺(R)₂, —SO₂R, —SOR, —SO₂N(R)₂, —SC(O)SR, —SC(S)SR, —Si(R)₃, or an optionally substituted radical selected from the group consisting of C₁₋₂₀ aliphatic; C₁₋₂₀ heteroaliphatic; phenyl; a 3- to 8-membered saturated or partially unsaturated monocyclic carbocycle, a 7- to 14-membered saturated, partially unsaturated or aromatic polycyclic carbocycle; a 5- to 6-membered monocyclic heteroaryl ring having 1-4 heteroatoms independently selected from nitrogen, oxygen, or sulfur; a 3- to 8-membered saturated or partially unsaturated heterocyclic ring having 1-3 heteroatoms independently selected from nitrogen, oxygen, or sulfur; a 6- to 12-membered polycyclic saturated or partially unsaturated heterocycle having 1-5 heteroatoms independently selected from nitrogen, oxygen, or sulfur; or an 8- to 10-membered bicyclic heteroaryl ring having 1-5 heteroatoms independently selected from nitrogen, oxygen, or sulfur; where two or more R^{d} groups may be taken together with intervening atoms to form one or more optionally substituted rings optionally containing one or more heteroatoms.
Embodiment 43. The nanostructured material of embodiment 42, wherein each \textcircled{A} is independently selected from the group consisting of:

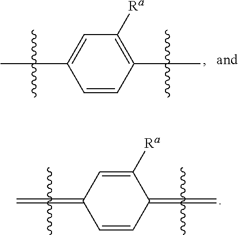

Embodiment 44. The nanostructured material of embodiment 42, wherein R^{a} is a sulfur-, selenium-, phosphorous-, tin-, or boron-containing functional group.
Embodiment 45. The nanostructured material of embodiment 44, wherein R^{a} comprises sulfur.
Embodiment 46. The nanostructured material of embodiment 45, wherein R^{a} is selected from the group consisting of: thiolate, sulfate, sulfonate, sulfenate, and sulfinate.
Embodiment 47. The nanostructured material of embodiment 46, wherein R^{a} comprises sulfonate.
Embodiment 48. The nanostructured material of embodiment 44, wherein R^{a} comprises phosphorous.
Embodiment 49. The nanostructured material of embodiment 48, wherein R^{a} is selected from the group consisting of: phosphate and phosphonate.
Embodiment 50. The nanostructured material of embodiment 44, wherein R^{a} comprises boronate, stannate, or selenate.
Embodiment 51. The nanostructured material of embodiment 44, wherein R^{a} comprises carboxylate.
Embodiment 52. The nanostructured material of embodiment 42, further comprising repeat units not substituted with anionic functional groups.
Embodiment 53. The nanostructured material of embodiment 52, wherein the polymer is characterized in that a ratio of repeat units comprising anionic functional groups to repeat units not comprising anionic functional groups is between 1:10 and 10:1, between 1:2 and 2:1, or between 1:1 and 10:1;
Embodiment 54. The nanostructured material of embodiment 52, wherein the polymer is characterized in that a ratio of repeat units comprising anionic functional groups to repeat units not comprising anionic functional groups is greater than 1:10, greater than 1:5, greater than 1:4, greater than 1:3, greater than 1:2, greater than 1:1, greater than 2:1, greater than 3:1, greater than 4:1, or greater than 5:1.

### VI. EXAMPLES

The following examples embody certain methods of the present disclosure and demonstrate the fabrication of a nanostructured materials according to certain embodiments herein.

### Example 1: Core Shell Nanoparticles Comprising Elemental Sulfur Cores Coated with an Anion-Functionalized Polymer Shell Comprising 10 Mol % Monomer Units Covalently Bound to —SO₃⁻ Anions

Sulfur nanoparticles were dispersed in an aqueous solution of polyvinylpyrrolidone (PVP) (1 wt %, 805 mL) and combined with DI water (85 mL) and 1M sulfuric acid (60 mL). Aniline (370 μL, 4.1 mmol) and aniline-2-sulfonic acid (78 mg, 0.45 mmol) were charged and the mixture was cooled in an ice bath. The reaction was sparged with nitrogen for 30 min and an aqueous solution of ammonium persulfate (50 mL, 0.2M) was added dropwise over 30 min. The reaction was stirred, under nitrogen, at 0° C. and allowed to warm to room temperature over 17 h. The reaction solids were isolated by centrifugation, washed twice with DI water, and dried for 4 h to produce a green powder.

### Example 2: Core-Shell Nanoparticles Comprising Elemental Sulfur Coated with an Anion-Functionalized Polymer Shell Comprising 20 Mol % Monomer Units Covalently Bound to —SO₃⁻ Anions

A reaction was performed according to the procedure of Example 1 except a higher ratio of sulfonate-substituted monomer was employed (3.6 mmol aniline, and 0.9 mmol aniline-2-sulfonic acid were used).

1. A nanostructured material comprising:
a polymer and an electroactive sulfur composition;
wherein,
the polymer is electrically conducting and has a structure comprising one or more anionic functional groups covalently bound to the polymer.

2. The nanostructured material of claim 1, wherein the one or more anionic functional groups contain one or more heteroatoms selected from the group consisting of: sulfur, selenium, nitrogen, phosphorous, tin, and boron, or combinations thereof.

3. The nanostructured material of claim 1, wherein at least one of the anionic functional groups comprises sulfur.

4. The nanostructured material of claim 3, wherein at least one of the anionic functional groups is selected from the group consisting of: thiolate, sulfate, sulfonate, sulfenate, and sulfinate, or combinations thereof.

5. The nanostructured material of claim 4, wherein at least one of the anionic functional groups comprises sulfonate.

6. The nanostructured material of claim 1, wherein at least one of the anionic functional groups comprises phosphorous.

7. The nanostructured material of claim 1, wherein at least one of the anionic functional groups comprises boron.

8. The nanostructured material of claim 1, wherein at least one of the anionic functional groups comprises tin.

9. The nanostructured material of claim 1, wherein at least one of the anionic functional groups is or comprises a carboxylate.

10. The nanostructured material of claim 1, wherein the electroactive sulfur composition is selected from the group consisting of: elemental sulfur, lithium sulfide, and a sulfur containing polymer, or combinations thereof.

11. The nanostructured material of claim 1, wherein the electrically conducting polymer comprises polyaniline.

12. The nanostructured material of claim 1, wherein the electrically conducting polymer is selected from the group consisting of a polyheterocycle, a poly-ene, or a polyarene.

13. The nanostructured material of claim 1, wherein the nanostructured material is in the form of nanoparticles.

14. The nanostructured material of claim 13, wherein the nanoparticles have a core shell morphology.

15. The nanostructured material of claim 14, wherein the shell comprises the electrically conducting polymer.

16. The nanostructured material of claim 14, wherein the core comprises the electroactive sulfur.

17. The nanostructured material of claim 13, wherein the nanostructured material comprises a yolk shell nanoparticle.

18. The nanostructured material of claim 17, wherein the shell comprises the electrically conducting polymer; the shell defines an interior volume, and the yolk comprises the electroactive sulfur and occupies between about 20% to about 80% of interior volume defined by the shell.

19. A mixture for use in the fabrication of a cathode comprising: a nanostructured material according to claim 1, an electrically conducting additive, and a binder.

20. A cathode derived from the mixture of claim 19.

21. An electrochemical cell comprising the cathode of claim 20.

22. A method for fabricating a nanostructured material,
the material comprising a polymer and an electroactive sulfur composition;
wherein,
the polymer is electrically conducting and has a structure comprising one or more anionic functional groups covalently bound to the polymer;
the method comprising a step of polymerizing a monomer comprising the anionic functional groups or a precursor to the anionic functional groups.

23. The method of claim 22, wherein the monomer comprising the anionic functional groups comprises sulfonated aniline.

24. The method of claim 22, wherein the monomer comprising anionic functional groups or functional group precursors is copolymerized with a monomer not containing anionic functional groups or functional group precursors.

25. A method for fabricating a nanostructured material,
the material comprising a polymer and an electroactive sulfur composition;
wherein,
the polymer is electrically conducting and has a structure comprising one or more anionic functional groups covalently bound to the polymer;
the method comprises a step of polymerizing a monomer not containing anionic functional groups to form the polymer and a subsequent step of modifying the polymer in a post-polymerizing step to introduce the anionic functional groups.

26. The method of claim 25, wherein the post-polymerization step comprises sulfonating the polymer.

27. A method for fabricating a nanostructured material,
the material comprising a polymer and an electroactive sulfur composition;
wherein,
the polymer is electrically conducting and has a structure comprising one or more anionic functional groups covalently bound to the polymer;
the method comprises a step of polymerizing a monomer under conditions that lead to concomitant functionalization of the polymer with the anionic functional groups or a precursor of such anionic functional groups.

28. A nanostructured material comprising:
a polymer and an electroactive sulfur composition;
wherein,
the polymer comprises repeat units conforming to formula M1: 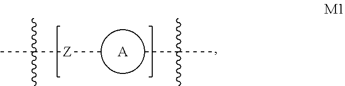
wherein:
Z is, independently at each occurrence in the polymer chain, selected from the group consisting of —N—, —NR—, —S—, and cations, radicals, radical cations or protonated versions of any of these, where R, at each occurrence is independently selected from the group consisting of —H, optionally substituted C₁₋₄ aliphatic, and optionally substituted aryl;
each dashed bond may, independently at each occurrence in the polymer chain, be a single bond or a double bond in conformance with the valences and charges of the atoms connected by such bond(s); and
\textcircled{A} is a non-heterocyclic aromatic moiety, where each \textcircled{A} may be the same or different at each occurrence in the polymer chain.
Wherein at least a portion of the \textcircled{A} groups in the polymer are substituted with anionic functional groups.

29. The nanostructured material of claim 28, wherein —Z— is —N— or —NR—.

30. The nanostructured material of claim 28, wherein \textcircled{A} comprises an optionally substituted phenylene.

31. The nanostructured material of claim 28, wherein each \textcircled{A} is independently selected from the group consisting of: 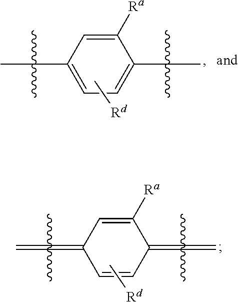
where;
R^{a} comprises an anionic functional group, and
R^{d} may be present or absent and when present may be present at one or more than one substitutable position on the ring, each R^{d} being independently selected at each occurrence from the group consisting of: an R^{a} group, a halogen atom, —OR, —OC(O)R′, —OCO₂R′, —OC(O)N(R′)₂, —OCN, —OSi(R)₃, —CO₂R, —C(O)N(R′)₂, —C(N)N(R′)₂, —CN, —C(S)OR′, —C(S)SR, —C(S)N(R)₂, —N(R)₂, —NRC(O)R, —NRCO₂R, —NRC(O)N(R)₂, —NRC(N)R, —NRC(N)N(R)₂, —N+(R)₃, —NRSO₂R, —NCO, —NO₂, —N₃, —NROR, —SR, —SR, —S⁺(R)₂, —SO₂R, —SOR, —SO₂N(R)₂, —SC(O)SR, —SC(S)SR, —Si(R)₃, or an optionally substituted radical selected from the group consisting of C₁₋₂₀ aliphatic; C₁₋₂₀ heteroaliphatic; phenyl; a 3- to 8-membered saturated or partially unsaturated monocyclic carbocycle, a 7- to 14-membered saturated, partially unsaturated or aromatic polycyclic carbocycle; a 5- to 6-membered monocyclic heteroaryl ring having 1-4 heteroatoms independently selected from nitrogen, oxygen, or sulfur; a 3- to 8-membered saturated or partially unsaturated heterocyclic ring having 1-3 heteroatoms independently selected from nitrogen, oxygen, or sulfur; a 6- to 12-membered polycyclic saturated or partially unsaturated heterocycle having 1-5 heteroatoms independently selected from nitrogen, oxygen, or sulfur; or an 8- to 10-membered bicyclic heteroaryl ring having 1-5 heteroatoms independently selected from nitrogen, oxygen, or sulfur; where two or more R^{d} groups may be taken together with intervening atoms to form one or more optionally substituted rings optionally containing one or more heteroatoms.

32. The nanostructured material of claim 31, wherein R^{a} is a sulfur-, selenium-, phosphorous-, tin-, or boron-containing functional group.

33. The nanostructured material of claim 32, wherein R^{a} comprises sulfur.

34. The nanostructured material of claim 33, wherein R^{a} is selected from the group consisting of: thiolate, sulfate, sulfonate, sulfenate, and sulfinate.

35. The nanostructured material of claim 34, wherein R^{a} comprises sulfonate.

36. The nanostructured material of claim 32, wherein R^{a} comprises phosphorous.

37. The nanostructured material of claim 32, wherein R^{a} comprises carboxylate.

38. The nanostructured material of claim 31, further comprising repeat units not substituted with anionic functional groups.

39. The nanostructured material of claim 38, wherein the polymer is characterized in that a ratio of repeat units comprising anionic functional groups to repeat units not comprising anionic functional groups is greater than 1:10, greater than 1:5, greater than 1:4, greater than 1:3, greater than 1:2, greater than 1:1, greater than 2:1, greater than 3:1, greater than 4:1, or greater than 5:1.
